(19) United States
(12) Patent Application Publication
(10) Pub. No.: US 2014/0049573 A1
(43) Pub. Date: Feb. 20, 2014

(54) IMAGE DISPLAY DEVICE AND IMAGE DISPLAY METHOD

(71) Applicant: Tomoyuki Ishihara, Osaka (JP)

(72) Inventor: Tomoyuki Ishihara, Osaka (JP)

(73) Assignee: SHARP KABUSHIKI KAISHA, Osaka-shi, Osaka (JP)

(21) Appl. No.: 14/114,269

(22) PCT Filed: May 11, 2012
(86) PCT No.: PCT/JP2012/062118

§ 371 Date: Oct. 28, 2013

(30) Foreign Application Priority Data
May 18, 2011 (JP) 2011-111520

(51) Int. Cl. G09G 5/02; G09G 3/36

(52) U.S. Cl. CPC G09G 5/026; G09G 3/3607
USPC 345/691; 345/88

(57) ABSTRACT

An image display device includes a color component ratio extracting unit that extracts a color component ratio for reproducing a target display color included in a target image as a light emission color component ratio candidate, a light emission color component ratio selecting unit that selects a light emission color component ratio (a color component ratio when LEDs of a plurality of colors included in an LED unit emit light) in each sub-frame period from among light emission color component ratio candidates extracted by the color component ratio extracting unit, and a pixel modulation degree calculating unit that obtains a light modulation degree of each pixel formation portion in each sub-frame period. One frame period is configured by a plurality of sub-frame periods in which mixed-color display is possible, and achromatic display is performed in at least one sub-frame period among the plurality of sub-frame periods.

### TECHNICAL FIELD

The present invention relates to an image display device and an image display method, and relates more particularly to a technique for suppressing occurrence of color breakup in an image display device using a field-sequential system.

### BACKGROUND ART

Many of liquid crystal display devices that perform color display include a color filter for transmitting light of a red color (R), a green color (G), and a blue color (B), for each sub-pixel obtained by dividing one pixel into three sub-pixels. However, because about two thirds of light of a backlight irradiated to a liquid crystal panel are absorbed by the color filter, a liquid crystal display device of a color filter system has a problem in that light-utilization efficiency of this device is low. Then, a liquid crystal display device of a field-sequential system that performs color display without using a color filter is being focused.

In the field-sequential system, a display period for one screen (one frame period) is divided into three sub-frames. Although the sub-frame is also called a sub-field, the term of sub-frame is consistently used in the following description. In a first sub-frame, a red color screen is displayed based on a red color component of an input signal. In a second sub-frame, a green color screen is displayed based on a green color component of an input signal. In a third sub-frame, a blue color screen is displayed based on a blue color component of an input signal. By performing display of each one color as described above, a color image is displayed in a liquid crystal panel. Because a color filter is not necessary in the liquid crystal display device of a field-sequential system as described above, light-utilization efficiency in the liquid crystal display device of the field-sequential system becomes about three times of that in the liquid crystal display device of a color filter system.

However, a field sequential color system has a problem in that color breakup (color break) occurs in this system. FIG. 31 is diagram showing a principle of occurrence of color breakup. In a part A in FIG. 31, a vertical axis represents time, and a lateral axis represents a position on a screen. In general, when an object moves in a display screen, an observer's line of sight follows the object and moves in a moving direction of the object. For example, in an example shown in FIG. 31, when a white color object moves from left to right in the display screen, the observer's line of sight moves in a diagonal arrow direction. On the other hand, when three sub-frame images of R, G, and B are extracted from video of the same moment, positions of objects in the respective sub-frame images are the same. Therefore, color breakup occurs in video seen on the retina as shown in a part B in FIG. 31.

Therefore, it has been proposed to make color breakup not noticeable by providing in one frame period a sub-frame for performing display of a color of non-three primary colors, that is, display of at least two colors (hereinafter, “mixed-color display”). For example, according to the invention disclosed in US Patent Application Publication No. 2010/0245396, one frame period includes three sub-frames for performing single-color display (red-color display, green-color display, and blue-color display) and one sub-frame for performing mixed-color display. Further, according to the invention disclosed in Japanese Patent Application Laid-Open No. 2009-134156, one frame period includes a sub-frame in which at least a light source of a green color emits light out of light sources of a red color, a green color, and a blue color, a sub-frame in which at least a light source of a red color emits light out of light sources of a red color and a blue color, and a sub-frame in which a light source of a blue color emits light.

### PRIOR ART DOCUMENTS

### Patent Documents

[Patent Document 1] US Patent Application Publication No. 2010/0245396
[Patent Document 2] Japanese Patent Application Laid-Open No. 2009-134156

### SUMMARY OF THE INVENTION

### Problems to be Solved by the Invention

In a display device using light sources of a red color, a green color, and a blue color, depending on a target image, it becomes necessary to perform mixed-color display (yellow-color display) using a red color and a green color, mixed-color display (magenta-color display) using a red color and a blue color, mixed-color display (cyan-color display) using a green color and a blue color, and mixed-color display (white-color display) using a red color, a green color, and a blue color. However, according to the invention disclosed in US Patent Application Publication No. 2010/0245396, only one sub-frame in which mixed-color display can be performed is provided in one frame period. Further, according to the invention disclosed in Japanese Patent Application Laid-Open No. 2009-134156, at most only two sub-frames in which mixed-color display can be performed are provided in one frame period. Therefore, according to a conventional display device, depending on colors that configure a target image, it is not possible to perform all mixed-color display necessary for display of the target image, by using only sub-frames in which mixed-color display can be performed. Therefore, it is necessary to perform mixed-color display by time division by using a plurality of sub-frames (for example, to perform yellow-color display, it is necessary to perform red-color display in a certain sub-frame and perform green-color display in another sub-frame). Consequently, color breakup easily occurs.

Therefore, an object of the present invention is to provide an image display device using a field-sequential system capable of more effectively suppressing occurrence of color breakup than a conventional practice.

### Means for Solving the Problems

A first aspect of the present invention is directed to an image display device that has a display unit including a plurality of pixel formation portions arranged in a matrix form and a light irradiating unit for irradiating the display unit with light, and that performs color display by dividing one frame period into a plurality of sub-frame periods and by changing over, in each sub-frame period, colors of light sources which become in a lighting-on state, the light irradiating unit including a light source group made up of light sources of a plurality of colors which are capable of controlling the lighting-on state/a lighting-off state for each color, wherein

one frame period is configured by a plurality of sub-frame periods in which mixed-color display is possible by setting light sources of a plurality of colors in the lighting-on state, and

achromatic display is performed in at least one sub-frame period among the plurality of sub-frame periods.

According to a second aspect of the present invention, in the first aspect of the present invention,

the light irradiating unit includes a plurality of light source groups so that each light source group corresponds to a part of the plurality of pixel formation portions, and

a color of a light source that is set in the lighting-on state in each sub-frame period is determined for each light source group.

According to a third aspect of the present invention, in the first aspect of the present invention,

the light sources of the plurality of colors included in the light source group are light sources of three colors of a red color, a green color, and a blue color, and

in a sub-frame period in which achromatic display is performed, light sources of a red color, a green color, and a blue color that are included in the light source group become in the lighting-on state with the same light emission intensity, or all light sources of a red color, a green color, and a blue color that are included in the light source group become in the lighting-off state.

According to a fourth aspect of the present invention, in the first aspect of the present invention,

the light sources of the plurality of colors included in the light source group are light sources of three colors of a red color, a green color, and a blue color, and

in a sub-frame period in which achromatic display is performed, light emission intensities of light sources of a red color, a green color, and a blue color included in the light source group are adjusted so that a color temperature of a display color becomes within a range of 5000 K to 13000 K.

According to a fifth aspect of the present invention, in the first aspect of the present invention,

the light sources of the plurality of colors included in the light source group are light sources of three colors of a red color, a green color, and a blue color, and

in a sub-frame period in which achromatic display is not performed, a light source of at least one color of light sources of a red color, a green color, and a blue color included in the light source group becomes in the lighting-off state.

According to a sixth aspect of the present invention, in the first aspect of the present invention,

the image display device comprises a color component ratio extracting unit for extracting a color component ratio for reproducing a target display color included in a target image as a light emission color component ratio candidate, from the target image to be displayed in the display unit with spending one frame period; and

a light emission color component ratio selecting unit for selecting as a light emission color component ratio a color component ratio when the light sources of a plurality of colors included in the light source group emit light in each sub-frame period, from among light emission color component ratio candidates extracted by the color component ratio extracting unit, wherein

each light source can take any light emission state of either the lighting-on state or the lighting-off state in each sub-frame period.

According to a seventh aspect of the present invention, in the sixth aspect of the present invention,

the light irradiating unit includes a plurality of light source groups so that each light source group corresponds to a part of the plurality of pixel formation portions,

the color component ratio extracting unit extracts the light emission color component ratio candidate from an image of a corresponding portion of the target image for each light source group, and

the light emission color component ratio selecting unit selects the light emission color component ratio for each light source group.

According to an eighth aspect of the present invention, in the first aspect of the present invention,

the image display device comprises a pixel modulation degree calculating unit that obtains a light modulation degree of each pixel formation portion in each sub-frame period, based on a light emission amount in each sub-frame period of the light sources of the plurality of colors included in the light source group and a target display color included in a target image to be displayed in the display unit with spending one frame period.

According to a ninth aspect of the present invention, in the eighth aspect of the present invention,

when a color component ratio in emitting light of the light sources of the plurality of colors included in the light source group is called a light emission color component ratio and also when any pixel formation portion is called a focused pixel formation portion, the pixel modulation degree calculating unit obtains a light modulation degree of the focused pixel formation portion in each sub-frame period so that a target display color is reproduced in the focused pixel formation portion in a sub-frame period in which a color component ratio of a target display color in the focused pixel formation portion and a light emission color component ratio of the light source group become nearest each other and that light from the light source group is shielded in the focused pixel formation portion in the other sub-frame periods.

According to a tenth aspect of the present invention, in the ninth aspect of the present invention,

when any pixel formation portion is called a focused pixel formation portion, and when a color reproduced in the focused pixel formation portion by mixing light emitted from the light source group in a plurality of sub-frame periods is nearer a target display color in the focused pixel formation portion than a color reproduced in the focused pixel formation portion by light emitted from the light source group in one sub-frame period, the pixel modulation degree calculating unit obtains a light modulation degree of the focused pixel formation portion in each sub-frame period so that a target display color is reproduced in the focused pixel formation portion by using the plurality of sub-frame periods and that light from the light source group is shielded in the focused pixel formation portion in the other sub-frame periods.

According to an eleventh aspect of the present invention, in the first aspect of the present invention,

the image display device comprises a color component ratio extracting unit for extracting a color component ratio for reproducing a target display color included in a target image as a light emission color component ratio candidate, from the target image to be displayed in the display unit with spending one frame period;

a light emission color component ratio selecting unit for selecting as a light emission color component ratio a color component ratio when the light sources of a plurality of colors included in the light source group emit light in each sub-frame period, from among light emission color component ratio candidates extracted by the color component ratio extracting unit;

a light emission amount calculating unit for obtaining a light emission amount in each sub-frame period of the light sources of the plurality of colors included in the light source group, based on a light emission color component ratio selected by the light emission color component ratio selecting unit; and a pixel modulation degree calculating unit for obtaining a light modulation degree of each pixel formation portion in each sub-frame period based on a light emission amount obtained by the light emission amount calculating unit and a target display color included in the target image.

According to a twelfth aspect of the present invention, in any one of the first to eleventh aspect of the present invention,

each pixel formation portion includes a pixel electrode, a common electrode which is an electrode provided in common in the plurality of pixel formation portions and is arranged to face the pixel electrode so as to be applied with a predetermined potential, and a liquid crystal sandwiched between the pixel electrode and the common electrode, and

the liquid crystal is driven by application of a potential based on a target image to be displayed in the display unit with spending one frame period to a pixel electrode included in each pixel formation portion.

A thirteenth aspect of the present invention is directed to an image display method in an image display device that has a display unit including a plurality of pixel formation portions arranged in a matrix form and a light irradiating unit for irradiating the display unit with light, and that performs color display by dividing one frame period into a plurality of sub-frame periods and by changing over, in each sub-frame period, colors of light sources which become in the lighting-on state, the light irradiating unit including a light source group made up of light sources of a plurality of colors which are capable of controlling the lighting-on state/a lighting-off state for each color, wherein

one frame period is configured by a plurality of sub-frame periods in which mixed-color display is possible by setting light sources of a plurality of colors in the lighting-on state, and

achromatic display is performed in one sub-frame period among the plurality of sub-frame periods.

### Effects of the Invention

According to the first aspect of the present invention, in an image display device that employs a field-sequential system, one frame period is configured by a plurality of sub-frame periods, and mixed-color display can be performed in all sub-frame periods. Therefore, even when mixed-color display of a plurality of patterns is necessary to reproduce a target image, mixed-color display of the plurality of patterns can be performed by using the plurality of sub-frame periods. Accordingly, the mixed-color display of the plurality of patterns can be performed in one frame period without using a time division system. From the above, in the image display device using a field-sequential system, occurrence of color breakup can be more effectively suppressed than a conventional practice. Further, at least one of a plurality of sub-frame periods that configure one frame period is set as a sub-frame period (achromatic sub-frame) for performing achromatic display. Chromatic display is performed in sub-frame periods (chromatic sub-frames) other than the achromatic sub-frame. Therefore, in reproducing a target display color, adjustment of a hue angle and adjustment of chromaticness can be performed in different sub-frame periods. Accordingly, arithmetic processing of a light modulation degree that is necessary to reproduce a target display color becomes easy.

According to the second aspect of the present invention, in an image display device which employs a field-sequential system and also employs a system for controlling brightness of the light source for each area, one frame period is configured by a plurality of sub-frame periods, and mixed-color display can be performed in all sub-frame periods. Therefore, even when mixed-color display of a plurality of patterns is necessary to reproduce a target image of an area corresponding to each light source group, mixed-color display of the plurality of patterns can be performed for each light source group by using the plurality of sub-frame periods. Accordingly, for each area, mixed-color display of the plurality of patterns can be performed in one frame period without using a time division system. From the above, in the image display device which employs a field-sequential system and also employs a system for controlling brightness of the light source for each area, occurrence of color breakup can be more effectively suppressed than a conventional practice. Further, in the image display device which employs a field-sequential system and also employs a system for controlling brightness of the light source for each area, arithmetic processing of a light modulation degree that is necessary to reproduce the target display color becomes easy like in the first aspect of the present invention.

According to the third aspect of the present invention, in an image display device that employs a field-sequential system by using light sources of three colors of a red color, a green color, and a blue color, an effect similar to that in the first aspect of the present invention is obtained.

According to the fourth aspect of the present invention, in an image display device that employs a field-sequential system by using light sources of three colors of a red color, a green color, and a blue color, an effect similar to that in the first aspect of the present invention is obtained.

According to the fifth aspect of the present invention, in an image display device that employs a field-sequential system by using light sources of three colors of a red color, a green color, and a blue color, an effect similar to that in the first aspect of the present invention is obtained.

According to the sixth aspect of the present invention, an image display device is configured to include a color component ratio extracting unit for extracting a color component ratio to reproduce a target display color as a light emission color component ratio, and a light emission color component ratio selecting unit for selecting a color component ratio when a light source group emits light in each sub-frame period, as a light emission color component ratio. As a result, an effect similar to that in the first aspect of the present invention is obtained.

According to the seventh aspect of the present invention, in an image display device which employs a field-sequential system and also employs a system for controlling brightness of a light source for each area, an effect similar to that in the first aspect of the present invention is obtained.

According to the eighth aspect of the present invention, a light modulation degree of each pixel formation portion in each sub-frame period can be suitably obtained, and occurrence of color breakup can be suppressed effectively while reproducing a color near a target display color.

According to the ninth aspect of the present invention, occurrence of color breakup can be suppressed effectively while reproducing a color near a target display color without complicating arithmetic processing of a light modulation degree that is necessary to reproduce a target display color.

According to the tenth aspect of the present invention, occurrence of color breakup can be suppressed effectively while reproducing a color nearer a target display color without complicating arithmetic processing of a light modulation degree that is necessary to reproduce a target display color.

According to the eleventh aspect of the present invention, an image display device is configured to include a color component ratio extracting unit for extracting a color component ratio to reproduce a target display color as a light emission color component ratio, and a light emission color component ratio selecting unit for selecting a color component ratio when a light source group emits light in each sub-frame period, as a light emission color component ratio. As a result, an effect similar to that in the first aspect of the present invention is obtained. Further, the image display device is configured to include a light emission amount calculating unit for obtaining a light emission amount of a light source group in each sub-frame period, and a pixel modulation degree calculating unit for obtaining a light modulation degree of each pixel formation portion in each sub-frame period. As a result, an effect similar to that in the sixth aspect of the present invention is obtained.

According to the twelfth aspect of the present invention, a liquid crystal display device that can suppress occurrence of color breakup more effectively than a conventional practice and also can easily perform arithmetic processing of a light modulation degree that is necessary to reproduce a target display color can be realized.

According to the thirteenth aspect of the present invention, it is possible to obtain an effect similar to that in the first aspect of the present invention in an image display method.

### BRIEF DESCRIPTION OF THE DRAWINGS

FIG. 1 is a block diagram showing an overall configuration of a liquid crystal display device according to a first embodiment of the present invention.

FIG. 2 is a view schematically showing a configuration of a backlight unit in the first embodiment.

FIG. 3 is a view for explaining a pixel area in a display unit in the first embodiment.

FIG. 4 is a diagram showing a configuration of a frame period in the first embodiment.

FIG. 5 is a diagram for explaining a mixed-color component.

FIG. 6 is a diagram for explaining a mixed-color component.

FIG. 7 is a diagram for explaining a mixed-color component.

FIG. 8 is a diagram for explaining a mixed-color component.

FIG. 9 is a flowchart showing a sequence of a sub-frame image generation process in the first embodiment.

FIG. 10 is a flowchart showing a sequence of a color component ratio extraction process in the first embodiment.

FIG. 11 is a diagram for explaining a color component ratio.

FIG. 12 is a view showing an example of a target image.

FIG. 13 is an enlarged view of an area indicated by a reference character 62 in FIG. 12.

FIG. 14 is an enlarged view of an area indicated by a reference character 63 in FIG. 12.

FIG. 15 is a diagram showing an example of a color component ratio in the first embodiment.

FIG. 16 is a diagram showing a color component ratio extracted as a light emission color component ratio candidate in the first embodiment.

FIG. 17 is a diagram for explaining calculation of required intensity in the first embodiment.

FIG. 18 is a flowchart showing a sequence of the light emission color component ratio selection process in the first embodiment.

FIG. 19 is a diagram for explaining a selection order of an LED unit in the light emission color component ratio selection process in the first embodiment.

FIG. 20 is a flowchart showing a sequence of a pixel modulation degree calculation process in the first embodiment.

FIG. 21 is a diagram for explaining a difference between a color of arrival light and a target display color in a first modification of the first embodiment.

FIG. 22 is a diagram showing a configuration of a frame period in a liquid crystal display device according to a second embodiment of the present invention.

FIG. 23 is a diagram showing an example of division into a chromatic portion and an achromatic portion in the second embodiment.

FIG. 24 is a diagram showing another example of division into a chromatic portion and an achromatic portion in the second embodiment.

FIG. 25 is a diagram showing an example of a color component ratio of a color including only an achromatic portion.

FIG. 26 is a flowchart showing a sequence of a color component ratio extraction process in the second embodiment.

FIGS. 27A to 27D are diagrams for explaining a color component ratio extraction process in the second embodiment.

FIG. 28 is a flowchart showing a sequence of a light emission color component ratio selection process in the second embodiment.

FIG. 29 is a flowchart showing a sequence of a pixel modulation degree calculation process in the second embodiment.

FIG. 30 is a diagram for explaining an effect in the second embodiment.

FIG. 31 is diagram showing a principle of occurrence of color breakup.

### MODES FOR CARRYING OUT THE INVENTION

Hereinafter, embodiments of the present invention are described with reference to the accompanying drawings.

### 1. First Embodiment

### 1. 1 Overall Configuration and Operation Overview

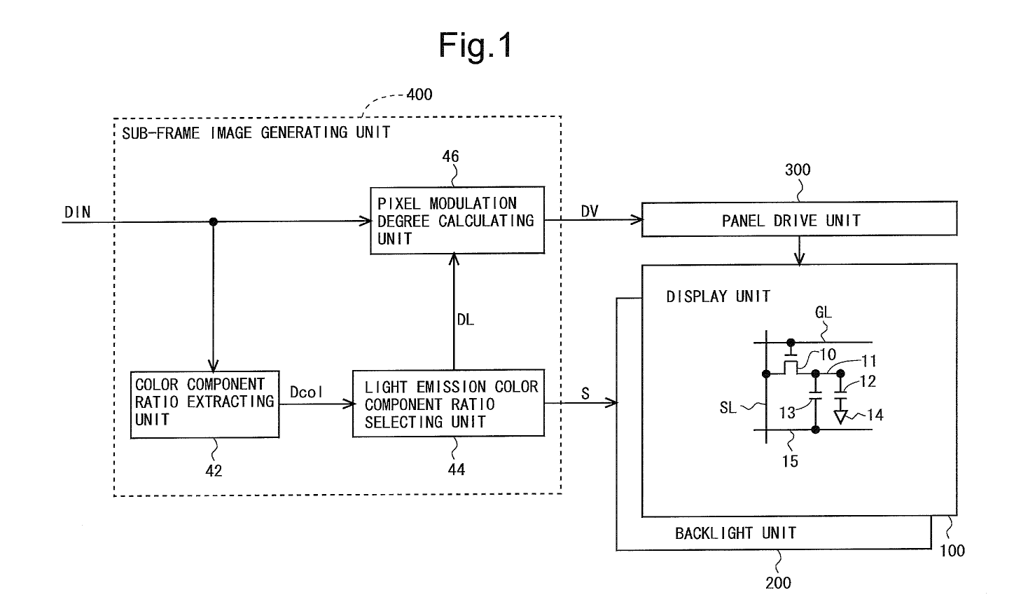

FIG. 1 is a block diagram showing an overall configuration of a liquid crystal display device according to a first embodiment of the present invention. This liquid crystal display device is configured by a display unit 100, a backlight unit 200, a panel drive circuit 300, and a sub-frame image generating unit 400. The sub-frame image generating unit 400 has a color component ratio extracting unit 42, a light emission color component ratio selecting unit 44, and a pixel modulation degree calculating unit 46. It should be noted that, in the present embodiment, a light irradiating unit is realized by the backlight unit 200.

In the display unit 100, a plurality of source bus lines (video signal lines) SL and a plurality of gate bus lines (scanning signal lines) GL are arranged. A pixel formation portion for forming a pixel is provided at the respective intersections of the source bus lines SL and the gate bus lines GL. That is, the display unit 100 includes a plurality of pixel formation portions. The plurality of pixel formation portions are arranged in a matrix form and thereby form a pixel array. Each pixel formation portion includes a TFT 10 which is a switching element having a gate terminal connected to a gate bus line GL passing through a corresponding intersection and a source terminal connected to a source bus line SL passing through the intersection, a pixel electrode 11 connected to a drain terminal of the TFT 10, a common electrode 14 and an auxiliary capacitance electrode 15 that are provided in common to the plurality of pixel formation portions, a liquid crystal capacitance 12 formed by the pixel electrode 11 and the common electrode 14, and an auxiliary capacitance 13 formed by the pixel electrode 11 and the auxiliary capacitance electrode 15. A pixel capacitance is configured by the liquid crystal capacitance 12 and the auxiliary capacitance 13. It should be noted that, in the display unit 100 in FIG. 1, constituent elements corresponding to only one pixel formation portion are shown.

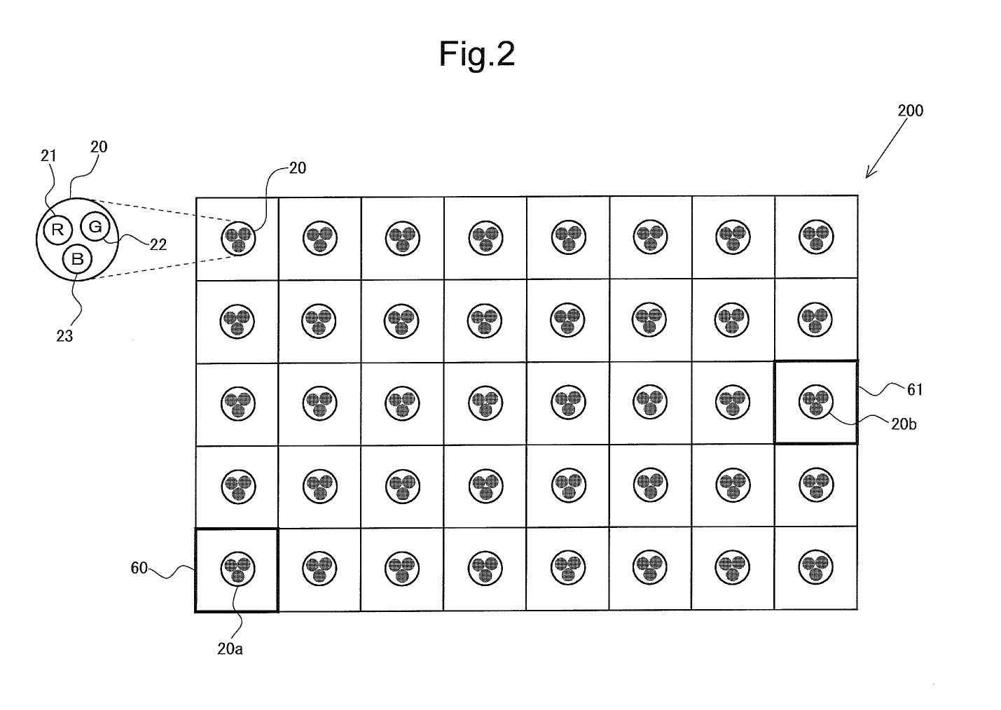

The backlight unit 200 is provided on a rear surface side of the display unit 100. The backlight unit 200 includes a plurality of light source groups, each including a light source of a red color, a light source of a green color, and a light source of a blue color. FIG. 2 is a view schematically showing a configuration of the backlight unit 200 in the present embodiment. In the present embodiment, an LED (Light Emitting Diode) is employed as a light source, and an LED unit 20 as a light source group includes one each of a red-color LED 21, a green-color LED 22, and a blue-color LED 23. As shown in FIG. 2, in the backlight unit 200, a plurality of LED units 20 are provided in a row direction and in a column direction, and are two-dimensionally arranged as a whole. It should be noted that the backlight unit 200 also includes an LED control circuit (not shown) that controls a state (a lighting-on state/a lighting-off state) of each LED.

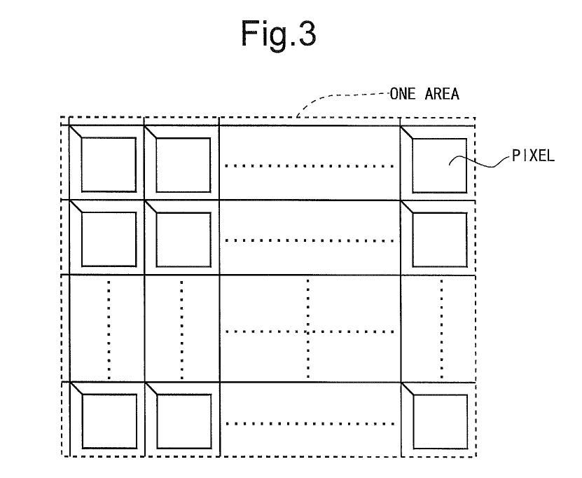

In the present embodiment, a pixel area in the display unit 100 is logically (not physically) divided into a plurality of areas so that one area includes a plurality of pixels (see FIG. 3). One LED unit 20 is related to one area. For example, an LED unit indicated by a reference character 20a is related to a thick-frame area indicated by a reference character 60 in FIG. 2, and an LED unit indicated by a reference character 20b is related to a thick-frame area indicated by a reference character 61 in FIG. 2. From the above, one area is related to a plurality of pixel formation portions. Light emitted from each LED unit 20A irradiates a pixel area of a corresponding area. Therefore, each LED unit 20 functions as a light source group for irradiating a plurality of pixel formation portions with red color light, green color light, and blue color light. It should be noted that, in the following, an area corresponding to each LED unit 20 is referred to as an “allocation area”.

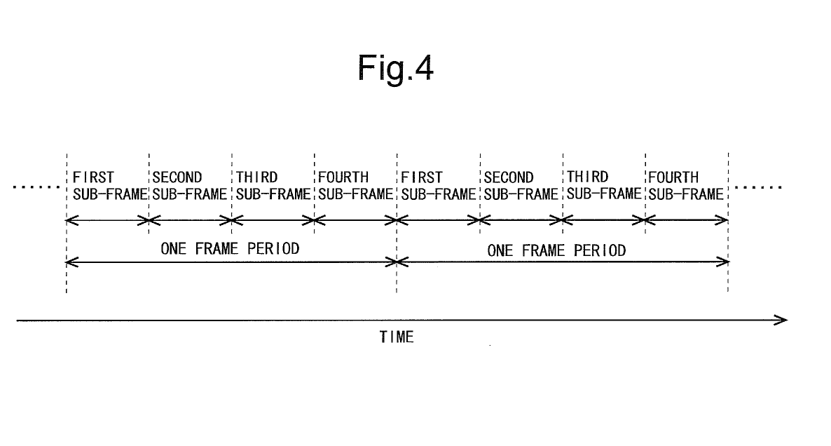

In the present embodiment, one frame period as a period for displaying an image for one screen is configured by four sub-frames (first to fourth sub-frames) as shown in FIG. 4. In each sub-frame, an LED of each color included in the LED unit 20 can take any state. Therefore, there are cases that only an LED of any one color becomes in a lighting-on state and LEDs of a plurality of colors (two colors or three colors) become in a lighting-on state. There is also a case that LEDs of all colors become in a lighting-off state. It should be noted that, in the following, regarding a state of an LED, a state including both a lighting-on state and a lighting-off state is referred to as a “light emission state”.

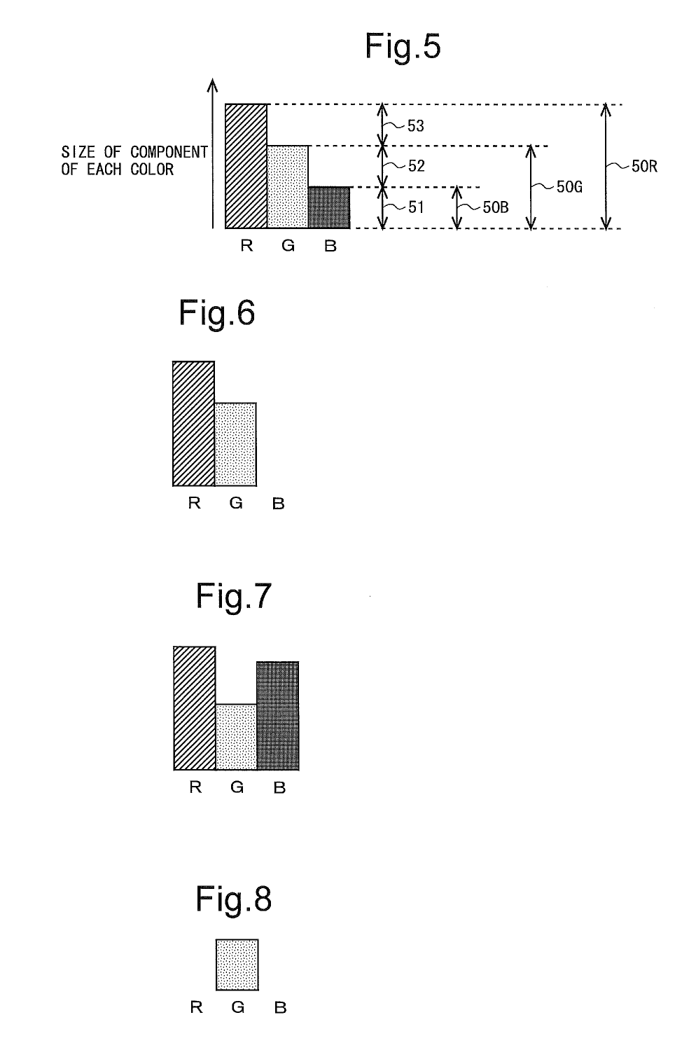

The mixed-color component is described below with reference to FIG. 5. In FIG. 5, sizes of single-color components of a red color (R), a green color (G), and a blue color (B) are shown in lengths in a vertical direction (similarly applied to FIG. 6 and others). For example, it is assumed that one pixel in a target image is configured by three single-color components of a red color component whose size is indicated by an arrow of a reference character 50R, a green color component whose size is indicated by an arrow of a reference character 50G, and a blue color component whose size is indicated by an arrow of a reference character 50B. At this time, it can be also considered that “this pixel is configured by a white color component whose size is indicated by an arrow of a reference character 51, a yellow color component whose size is indicated by an arrow of a reference character 52, and a red color component whose size is indicated by an arrow of a reference character 53”. It should be noted that the white color component is a mixed-color component of three colors including a red color component, a green color component, and a blue color component. The yellow color component is a mixed-color component of two colors including a red color component and a green color component. As described above, a component obtained by mixing two or more color components is referred to as a “mixed-color component”.

As described above, in the present embodiment, an LED of each color included in the LED unit 20 can take any light emission state in any sub-frame. Therefore, in each sub-frame in one frame period, display of a mixed-color component (mixed-color display) as described above can be performed by setting LEDs of a plurality of colors in a lighting-on state. For example, display of a yellow color component can be performed as mixed-color display in a certain sub-frame, by setting the red-color LED 21 and the green-color LED 22 in a lighting-on state in this sub-frame as shown in FIG. 6. Further, display of a white color component and display of a cyan color component can be performed as mixed-color display in a certain sub-frame, by setting the red-color LED 21, the green-color LED 22, and the blue-color LED 23 in a lighting-on state in this sub-frame as shown in FIG. 7. It should be noted that in any sub-frame, depending on a target image, an LED of only one color becomes in a lighting-on state as shown in FIG. 8, for example, and display of only a single-color component is performed.

Next, an overview of an operation of each constituent element shown in FIG. 1 is described. It should be noted that, in the following, a ratio of sizes of three color components (ratio of a size of a red color component, a size of a green color component, and a size of a blue color component) is referred to as a “color component ratio”. Further, a color component ratio of colors that can be displayed by LEDs of three colors included in the LED unit 20 is particularly referred to as a “light emission color component ratio candidate”. Further, a color component ratio of colors when LEDs of three colors included in the LED unit 20 actually emit is particularly referred to as a “light emission color component ratio”.

The color component ratio extracting unit 42 in the sub-frame image generating unit 400 extracts a color component ratio which is necessary to reproduce a color (target display color) constituting a target image, as a light emission color component ratio candidate, for each LED unit 20, based on the target image. The number of light emission color component ratio candidates extracted by the color component ratio extracting unit 42 for each LED unit 20 may be one or plural. It should be noted that the target image is an image for one frame based on an input image signal DIN transmitted from outside. The color component ratio extracting unit 42 outputs data indicating the extracted light emission color component ratio candidate, as color component ratio data Dcol.

The light emission color component ratio selecting unit 44 in the sub-frame image generating unit 400 receives the color component ratio data Dcol output from the color component ratio extracting unit 42, and selects, for each LED unit 20, a light emission color component ratio in each sub-frame from among light emission color component ratio candidates indicated by the color component ratio data Dcol. The light emission color component ratio selecting unit 44 further obtains a light emission amount of an LED of each color in each sub-frame, based on a color component ratio of the selected light emission color component ratio candidate. Further, the light emission color component ratio selecting unit 44 outputs data indicating a light emission amount of an LED of each color included in each LED unit 20 in each sub-frame as light emission data DL. Note that, depending on a target image, “setting in a lighting-off state” may be determined without selection of a light emission color component ratio from among light emission color component ratio candidates indicated by the color component ratio data Dcol. The light emission color component ratio selecting unit 44 also outputs a light source control signal S to control an operation of the backlight unit 200 so that each LED becomes in a desired light emission state (lighting-on state/lighting-off state). It should be noted that the light source control signal S may be a signal indicating a lighting-on state/a lighting-off state (ON/OFF in a time direction) of each LED, or may be a signal indicating brightness of each LED, or may be a combination of these signals.

The pixel modulation degree calculating unit 46 in the sub-frame image generating unit 400 generates and outputs a digital video signal DV as a signal for controlling a time aperture ratio of a liquid crystal in each pixel formation portion in each sub-frame so that a color of each pixel becomes a target display color, based on the input image signal DIN and the light emission data DL output from the light emission color component ratio selecting unit 44. It should be noted that the time aperture ratio corresponds to a temporal integration value of a light transmission rate of a liquid crystal in a light source lighting-on period, and actually-displayed brightness is determined by temporal superposition of a time aperture ratio of a liquid crystal and a light source lighting-on period.

The panel drive circuit 300 selectively drives the gate bus lines GL one by one, and applies a driving video signal to each source bus line SL based on the digital video signal DV output from the pixel modulation degree calculating unit 46. A predetermined potential is applied to the common electrode (a constant potential is applied, or a constant high potential and a constant low potential are alternately applied every predetermined period), and a potential based on a video signal for driving is applied to the pixel electrode 11. Accordingly, a desired electric charge is accumulated in a pixel capacitance in each pixel formation portion. The backlight unit 200 controls a light emission state of each LED based on the light source control signal S output from the light emission color component ratio selecting unit 44. As for the light emission control of the LED, light emission intensity may be controlled by adjusting a current, or light emission intensity may be adjusted by adjusting a length of a light emission period, or both methods may be combined.

By operating each constituent element in a manner described above, a display state of a screen is changed over every sub-frame, and an image (target image) based on the input image signal DIN is displayed in the display unit 100 with spending one frame period.

### 1. 2 Sub-Frame Image Generation Process

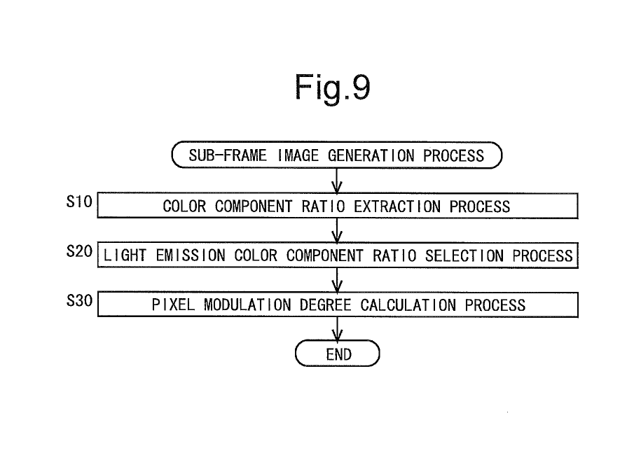

Next, a process performed by the sub-frame image generating unit 400, specifically, a process (sub-frame image generation process) for generating a display image of each sub-frame based on a target image for one frame is explained. FIG. 9 is a flowchart showing a sequence of the sub-frame image generation process. First, the above process (color component ratio extraction process) by the color component ratio extracting unit 42 is performed (step S10). Next, the above process (light emission color component ratio selection process) is performed by the light emission color component ratio selecting unit 44 (step S20). Last, the above process (pixel modulation degree calculation process) is performed by the pixel modulation degree calculating unit 46 (step S30). Hereinafter, the color component ratio extraction process, the light emission color component ratio selection process, and the pixel modulation degree calculation process are described in detail. Note that, regarding each process, a sequence shown below is an example, and a specific sequence is not particularly limited.

<1. 2. 1 Color Component Ratio Extraction Process>

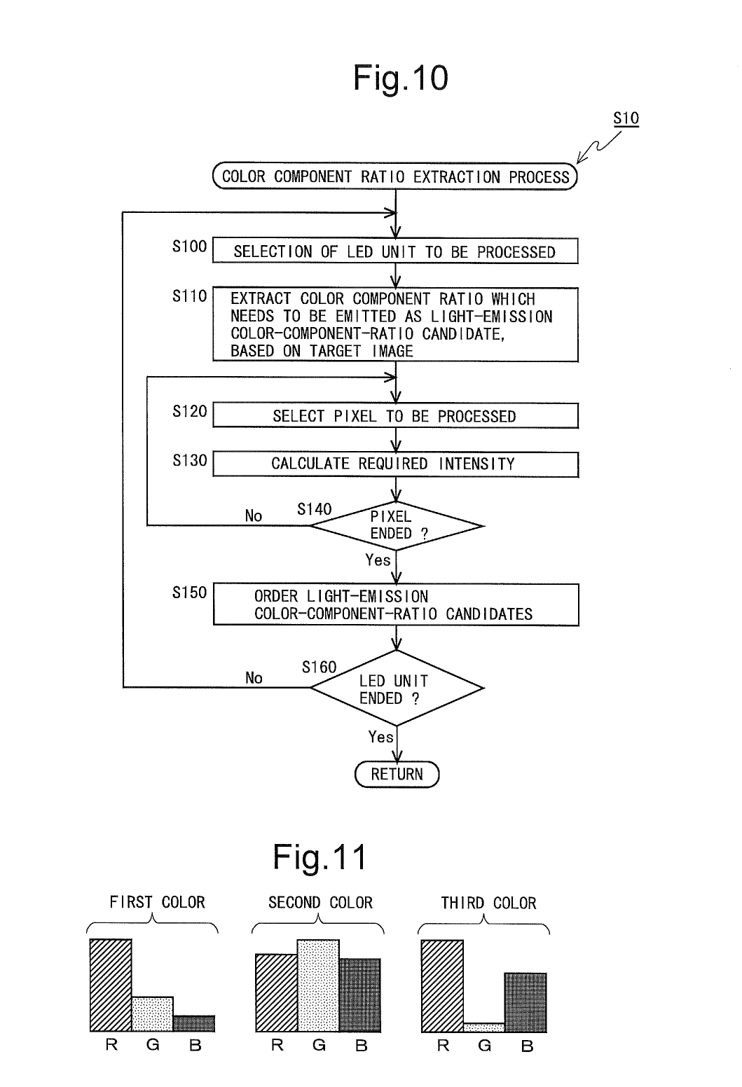

FIG. 10 is a flowchart showing a sequence of the color component ratio extraction process in the present embodiment. First, one LED unit 20 to be processed is selected from among a plurality of LED units 20 included in the backlight unit 200 (step S100). It should be noted that the LED unit 20 selected in step S100 is hereinafter referred to as a “selected LED unit”. Next, based on a target image in an allocation area of the selected LED unit, a color component ratio necessary to reproduce a color (target display color) that configures the target image is extracted as a light emission color component ratio candidate (step S110). For example, when four target display colors are included in a target image, four color component ratios are extracted as a light emission color component ratio candidate.

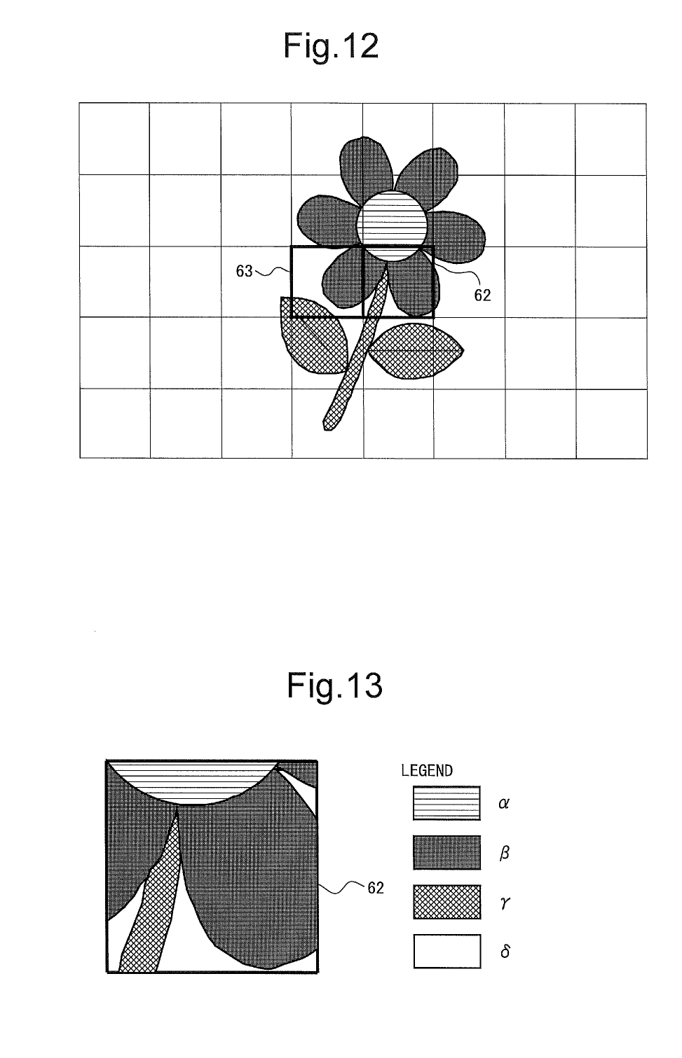

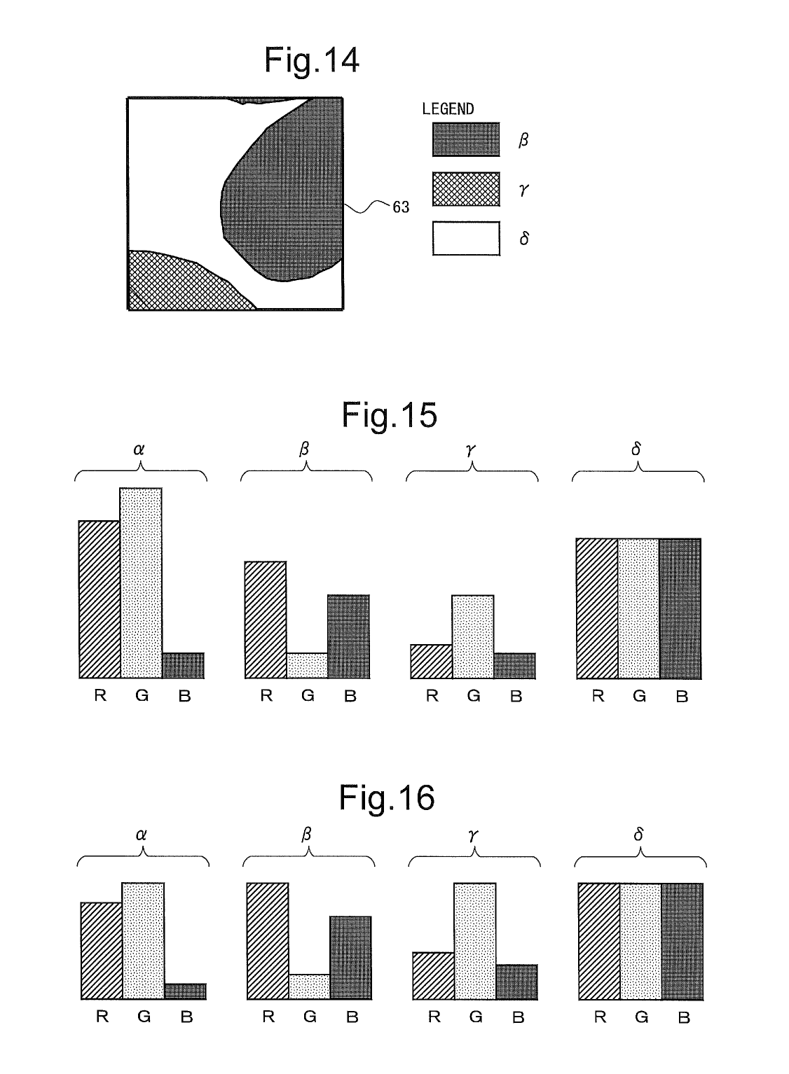

A color component ratio is described below with reference to FIG. 11 to FIG. 16. Assuming that three colors (first to third colors) are included as target display colors in a target image, color component ratios for the respective three colors are expressed as shown in FIG. 11, for example. The color component ratio expresses a relative relationship between respective sizes of a red color component, a green color component, and a blue color component, and does not express a size (component value) of each color component. Therefore, regarding FIG. 11, for example, a size of a red color component in a first color is not necessarily larger than a size of a red color component in a second color. Next, an image shown in FIG. 12 is considered. It is assumed that in a target image in an area indicated by a reference character 62 in FIG. 12, four colors (color component ratios of respective colors are α, β, γ, and δ) are included as target display colors as shown in FIG. 13. Also, it is assumed that in a target image in an area indicated by a reference character 63 in FIG. 12, three colors (color component ratios of respective colors are β, γ, and δ) are included as target display colors as shown in FIG. 14. Further, when respective sizes (color component values) of a red color component, a green color component, and a blue color component are also taken into account for the color component ratios α, β, γ, and δ, the sizes are assumed to be expressed as shown in FIG. 15. In such a case, when the LED unit 20 in the area indicated by the reference character 62 is the selected LED unit, color component ratios as expressed by α, β, γ, and δ in FIG. 16 are extracted as light emission color component ratio candidates. Further, when the LED unit 20 in the area indicated by the reference character 63 is the selected LED unit, color component ratios as expressed by β, γ, and δ in FIG. 16 are extracted as light emission color component ratio candidates.

After step S110 as described above ends, one pixel to be processed is selected from among a plurality of pixels included in an allocation area of the selected LED unit (step S120). Note that, the pixel selected in step S120 is hereinafter referred to as a “selected pixel”. Next, to perform ordering of light emission color component ratio candidates in step S150 described later for each LED unit 20, required intensity for the selected pixel is calculated (step S130). In the present embodiment, a required intensity calculating unit is realized by this step S130.

Next, the required intensity is described. The required intensity is calculated for each pixel, and is related to a light emission color component ratio necessary to reproduce a target display color of each pixel. Required intensity D1 is calculated by the following equation (1), by taking account of color intensity D2 and a light source influence degree D3.

D1=D2×D3 (1)

In the present embodiment, the largest value among respective component values of a red color component, a green color component, and a blue color component in the selected pixel is set as the color intensity D2. Therefore, in the example shown in FIG. 15, “first order: α, second order: δ, third order: β, fourth order: γ” is established for the color intensity D2. The light source influence degree D3 is a value determined depending on a distance from an LED to the selected pixel, an optical design of the backlight unit 200, and the like. It should be noted that the optical design is a design regarding a layout interval of the LED units 20 in the backlight unit 200 (for example, a design that “a density is set higher in a central portion than in a peripheral portion”) and the like.

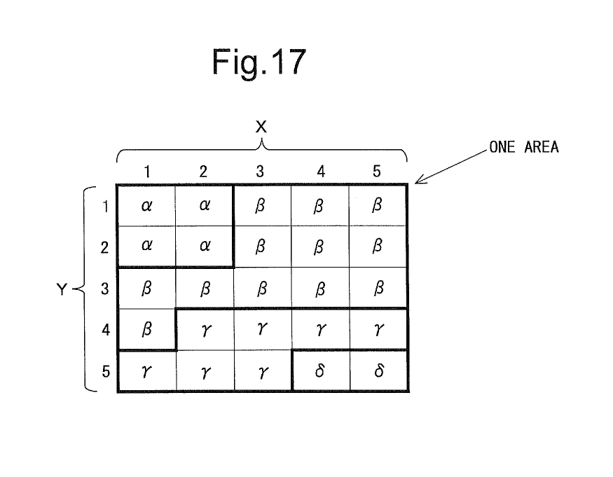

It is assumed, for example, that each area contains 25 (five in an X-axis direction, and five in a Y-axis direction) pixels, and that light emission color component ratios necessary to reproduce a target display color of each pixel are as shown in FIG. 17. In this case, required intensity is obtained for each of the 25 pixels. Further, required intensity of a pixel of (X, Y)=(2, 1) is related to a light emission color component ratio candidate a, for example, and required intensity of a pixel of (X, Y)=(3, 4) is related to a light emission color component ratio candidate γ, for example. In this way, in the example shown in FIG. 17, required intensities of four pixels are related to the light emission color component ratio candidate α, required intensities of 12 pixels are related to the light emission color component ratio candidate β, required intensities of seven pixels are related to the light emission color component ratio candidate γ, and required intensities of two pixels are related to the light emission color component ratio candidate δ.

It should be noted that a total value of component values of a red color component, a green color component, and a blue color component in the selected pixel may be set as the color intensity D2. Further, by taking account of a visibility characteristic of each color, a value obtained by weighted-averaging component values of a red color component, a green color component, and a blue color component may be set as the color intensity D2. In this way, a specific value of the color intensity D2 used in the above equation (1) is not particularly limited as long as the color intensity D2 is obtained based on a size (component value) of a component of each color for reproducing a target display color.

After step S130 as described above ends, it is decided whether or not calculation of required intensities regarding all pixels included in the allocation area of the selected LED unit has ended (step S140). As a result of the decision, when the calculation has ended, the process proceeds to step S150, and when the calculation has not ended, the process returns to step S120.

In step S150, regarding the selected LED unit, ordering of light emission color component ratio candidates is performed. In performing the ordering of light emission color component ratio candidates, first, color component ratio intensity is obtained for each light emission color component ratio candidate. In the present embodiment, the largest value of required intensities that are related to each light emission color component ratio candidate is set as color component ratio intensity of the corresponding light emission color component ratio candidate. In the example shown in FIG. 17, the largest value out of required intensities of the four pixels related to the light emission color component ratio candidate α becomes color component ratio intensity of the light emission color component ratio candidate α. Color component ratio intensity of each of the light emission color component ratio candidates β, γ, and δ is also obtained in a similar manner. After the color component ratio intensity of each light emission color component ratio candidate is obtained in this way, orders (priority orders) are allocated to the light emission color component ratio candidates in a high order of color component ratio intensities. For example, when “color component ratio intensities of the light emission color component ratio candidates α, β, γ, and δ are 100, 200, 10, and 150, respectively” regarding a selected LED unit, ordering is performed in such a way that “a first order: the light emission color component ratio candidate β, a second order: the light emission color component ratio candidate δ, a third order: the light emission color component ratio candidate α, and a fourth order: the light emission color component ratio candidate γ” is established. In the present embodiment, a light emission color component ratio ordering unit is realized by this step S150.

After step S150 ends, it is decided whether or not ordering of light emission color component ratio candidates has ended regarding all LED units 20 included in the backlight unit 200 (step S160). As a result of the decision, when the ordering has not ended, the process returns to step S100, and when the ordering has ended, the color component ratio extraction process ends.

In a manner as described above, in the color component ratio extraction process, from a target image, color component ratios for reproducing target display colors included in the target image are extracted as light emission color component ratio candidates. Further, required intensity is obtained for each pixel formation portion, by multiplying a color intensity as a value based on a size of a component of each color for reproducing a target display color by a light source influence degree indicating a size of an influence that each pixel formation portion receives based on light emitted from the corresponding LED unit 20. Then, in ordering the light emission color component ratio candidates, a higher order is set to a light emission color component ratio candidate corresponding to a color component ratio of a color that is to be reproduced by a pixel formation portion having larger required intensity.

<1. 2. 2 Light Emission Color Component Ratio Selection Process>

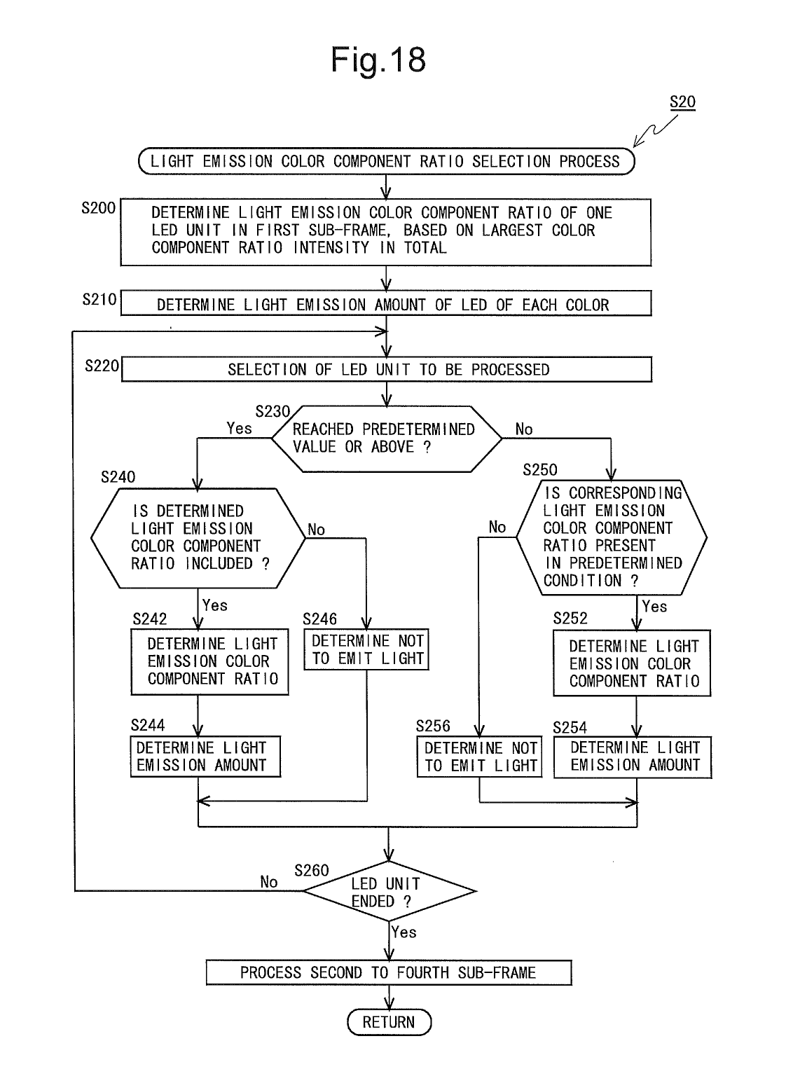

FIG. 18 is a flowchart showing a sequence of the light emission color component ratio selection process in the present embodiment. First, a light emission color component ratio of one LED unit 20 in a first sub-frame is determined based on the largest value out of color component ratio intensities obtained by the color component ratio extraction process (step S200). Specifically, the LED unit 20 related to the largest color component ratio intensity is focused (the focused LED unit 20 is hereinafter referred to as a “focused LED unit”), and a light emission color component ratio candidate having the largest color component ratio intensity is set as a light emission color component ratio of the focused LED unit in the first sub-frame. It should be noted that, when a plurality of color component ratio intensities become largest values in the same values, it is preferable that the LED unit 20 arranged at a position nearest a center of the display unit 100 out of the LED units 20 that are related to the plurality of color component ratio intensities is set as a focused LED unit. This is because a person tends to first focus on a center of the display unit 100 when looking at a display device.

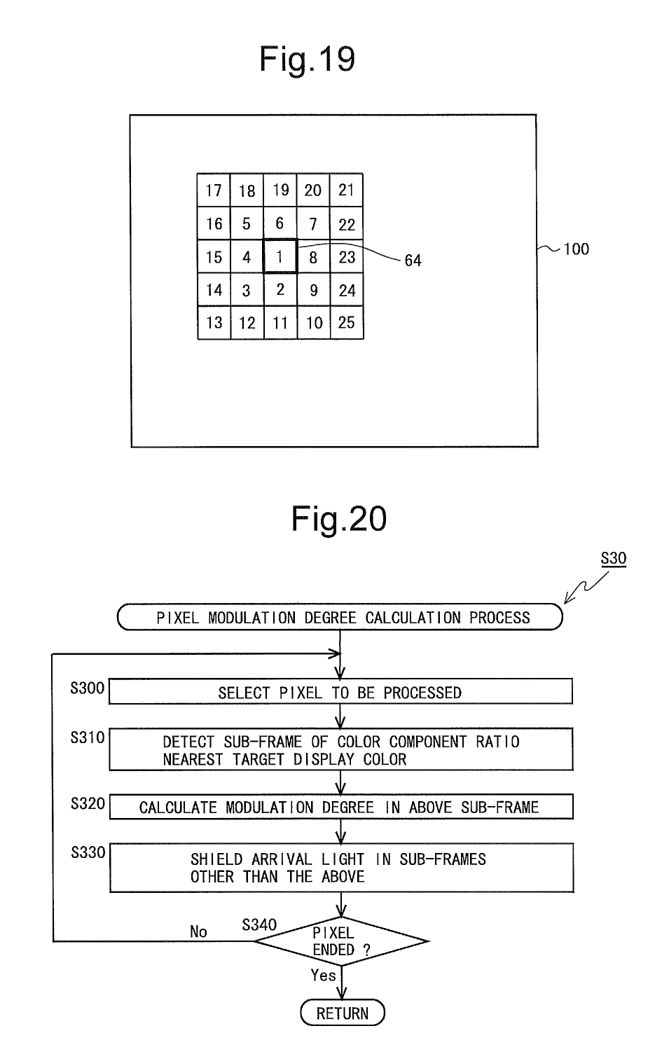

After step S200 ends, a light emission amount of an LED of each color included in the focused LED unit is determined, by taking account of brightness to be displayed in a pixel formation portion that requires a largest amount of arrival light in the allocation area of the focused LED unit (step S210). Next, one LED unit 20 to be processed is selected from among the plurality of LED units 20 included in the backlight unit 200 (step S220). Note that, also in this case, the selected LED unit 20 is referred to as a “selected LED unit”. In step S220, one LED unit 20 adjacent to the LED unit 20 of which a light emission color component ratio has been already determined is selected. For example, when a light emission color component ratio of the LED unit 20 corresponding to an area indicated by a reference character 64 in FIG. 19 is first determined, the LED unit 20 corresponding to each area is selected in an order of numbers shown in areas in FIG. 19. That is, taking the area where a light emission color component ratio is first determined as a center, a light emission color component ratio of the LED unit 20 corresponding to each area is determined in order from the center area to outsider areas.

After step S220 ends, it is decided whether or not light whose amount is equal to or larger than a prescribed value arrives at the allocation area of the selected LED unit due to the light emitted from the LED unit 20 of which a light emission color component ratio and a light emission amount have been already determined (step S230). As a result of the decision, when light whose amount is equal to or larger than a prescribed value arrives, the process proceeds to step S240, and when light whose amount is equal to or larger than a prescribed value does not arrive, the process proceeds to step S250.

In step S240, it is decided whether or not a light emission color component ratio of the LED unit 20 that has been already processed (a light emission color component ratio has been already determined) is included in light emission color component ratio candidates of the selected LED unit. As a result of the decision, when the light emission color component ratio is included, the process proceeds to step S242, and when the light emission color component ratio is not included, the process proceeds to step S244.

In step S242, a light emission color component ratio that is decided to be included in them in step S240 is set as a light emission color component ratio of the selected LED unit. Thereafter, in step S244, a light emission amount of an LED of each color included in the selected LED unit is determined, by taking account of brightness to be displayed in a pixel formation portion that requires a largest amount of arrival light in the allocation area of the selected LED unit. On the other hand, in step S246, it is determined that the selected LED unit in this sub-frame does not emit light. After step S244 or step S246 ends, the process proceeds to step S260. It should be noted that a reason for determining a light emission color component ratio as described above is to suppress occurrence of color crosstalk.

In step S250, it is decided whether or not a light emission color component ratio candidate corresponding to a predetermined condition is present. As a result of the decision, when such a light emission color component ratio candidate is present, the process proceeds to step S252, and when such a light emission color component ratio candidate is not present, the process proceeds to step S254. The light emission color component ratio candidate corresponding to a predetermined condition is a light emission color component ratio candidate that satisfies both a first condition and a second condition described below. Note that, a decision about whether or not each light emission color component ratio candidate corresponds to the following conditions is made starting from a light emission color component ratio candidate of which order is high, based on the ordering performed by step S150 in the color component ratio extraction process (see FIG. 10).

The first condition: a light emission color component ratio candidate in which it is not yet determined that the LED unit performs light emission at the color component ratio thereof, out of light emission color component ratio candidates of the selected LED unit.

The second condition: a light emission color component ratio candidate in which an amount of arrival light to an allocation area of an adjacent LED unit 20 becomes smaller than a prescribed value even when an LED unit becomes in a lighting-on state of a required light emission amount.

In step S252, a light emission color component ratio candidate that matches the condition in step S250 is set as a light emission color component ratio of the selected LED unit. Thereafter, in step S254, a light emission amount of an LED of each color included in the selected LED unit is determined, by taking account of brightness to be displayed in a pixel formation portion that requires the largest amount of arrival light in the allocation area of the selected LED unit. On the other hand, in step S256, it is determined that the selected LED unit in this sub-frame does not emit light. After step S254 or step S256 ends, the process proceeds to step S260.

In step S260, it is decided whether or not determination of a light emission color component ratio in this sub-frame has ended regarding all LED units 20 included in the backlight unit 200. As a result of the decision, when the determination has not ended, the process returns to step S220. On the other hand, when the determination has ended, processes in second to fourth sub-frames are performed in order, in a similar manner to that in the first sub-frame. Note that, in the second and subsequent sub-frames, first, a light emission color component ratio candidate, in which it is not yet determined that the LED unit 20 performs light emission at the color component ratio thereof, is extracted out of the light emission color component ratio candidates of all LED units 20. Then, the LED unit 20 that is related to the largest color component ratio intensity out of color component ratio intensities of the extracted light emission color component ratio candidates is set as a focused LED unit, and the light emission color component ratio candidate having largest color component ratio intensity is set as a light emission color component ratio of the focused LED unit in a sub-frame that is being processed.

Focusing attention on only a relationship between the area indicated by the reference character 62 and the area indicated by the reference character 63 in FIG. 12, a specific way of determining a light emission color component ratio in the present embodiment is described. Note that, for the convenience of description, the LED unit 20 provided corresponding to the area 62 is referred to as a “first unit”, and the LED unit 20 provided corresponding to the area 63 is referred to as a “second unit”. It is assumed that regarding color component ratio intensities, “a first order: the light emission color component ratio candidate α of the first unit, a second order: the light emission color component ratio candidate δ of the second unit, a third order: the light emission color component ratio candidate β of the second unit, a fourth order: the light emission color component ratio candidate β of the first unit, a fifth order: the light emission color component ratio candidate γ of the first unit, a sixth order: the light emission color component ratio candidate δ of the first unit, and a seventh order: the light emission color component ratio candidate γ of the second unit” is established. Further, it is assumed that even when the LED unit becomes in a lighting-on state based on any light emission color component ratio candidate, due to light emitted from an LED unit in one of the areas, light whose amount is equal to or larger than a prescribed value arrives at the other area. When the light emission color component ratio selection process is performed in the above conditions, the light emission color component ratios of the first unit and the second unit in each sub-frame are determined as follows.

First, because the first order of color component ratio intensity is the light emission color component ratio candidate a of the first unit, the light emission color component ratio candidate α is set as a light emission color component ratio of the first unit in the first sub-frame. Light whose amount is equal to or larger than a prescribed value arrives at the area 63 due to light emitted from the first unit, and the second unit does not have the light emission color component ratio candidate α. Therefore, it is determined that the second unit does not emit light in the first sub-frame. Next, a light emission color component ratio candidate that has the largest color component ratio intensity among light emission color component ratio candidates remaining at this stage is the light emission color component ratio candidate δ of the second unit in the second order. Therefore, the light emission color component ratio candidate δ is set as a light emission color component ratio of the second unit in the second sub-frame. Light whose amount is equal to or larger than a prescribed value arrives at the area 62 due to light emitted from the second unit, and the first unit has the light emission color component ratio candidate δ. Therefore, the light emission color component ratio candidate δ is set as a light emission color component ratio of the first unit in the second sub-frame. Hereinafter, in a similar manner, the light emission color component ratio candidate β is set as light emission color component ratios of the first unit and the second unit in the third sub-frame, and the light emission color component ratio candidate γ is set as light emission color component ratios of the first unit and the second unit in the fourth sub-frame.

In a manner as described above, in the light emission color component ratio selection process, for each LED unit, a light emission color component ratio in each sub-frame is selected from among light emission color component ratio candidates extracted by the color component ratio extraction process. Here, in the case where any LED unit 20 is set as a focused LED unit, when an LED unit adjacent to the focused LED unit does not irradiate a pixel formation portion corresponding to the focused LED unit with light equal to or larger than a predetermined amount, a light emission color component ratio candidate in a higher order is selected as a light emission color component ratio of the focused LED unit in a more preceding sub-frame period. When any sub-frame is set as a focused sub-frame and when, regarding adjacent two LED units, an LED unit of which a light emission color component ratio in the focused sub-frame is first selected is set as a first LED unit and the other LED unit is set as a second LED unit, and when the first LED unit irradiates a pixel formation portion corresponding to the second LED unit in the focused sub-frame with light equal to or larger than a predetermined amount, it is determined that an LED included in the second LED unit is set in a lighting-off state in the focused sub-frame.

It should be noted that, in the present embodiment, a light emission amount calculating unit is realizedby step S210, step S244, and step S254 in the light emission color component ratio selection process.

<1. 2. 3 Pixel Modulation Degree Calculation Process>

FIG. 20 is a flowchart showing a sequence of the pixel modulation degree calculation process in the present embodiment. First, one pixel to be processed is selected from the display unit 100 as a whole (step S300). Also in this case, the pixel selected in step S300 is referred to as a “selected pixel”. Next, a sub-frame is detected, in which light arrives whose color component ratio is nearest to a target display color out of color component ratios of light which arrives at the selected pixel (step S310). Note that, the sub-frame detected in step S310 is referred to as a “detected sub-frame”. Next, a light modulation degree of the selected pixel in the detected sub-frame is calculated (step S320). Note that, as used herein the “light modulation degree” means a degree of light emitted from a light source to an outside, and a desired light modulation degree is obtained by controlling an application voltage to a liquid crystal. In this step S320, a light modulation degree is determined so that a target display color appears in the selected pixel in the detected sub-frame. Next, a light modulation degree of a selected pixel in a sub-frame other than the detected sub-frame is determined (step S330). In this step S330, a light modulation degree is determined so that arrival light in a sub-frame other than the detected sub-frame is shielded. Next, it is decided whether or not calculation of light modulation degrees of all pixels in the display unit 100 has ended (step S340). As a result of the decision, when the calculation has not ended, the process returns to step S300, and when the calculation has ended, the pixel modulation degree calculation process ends.

In a manner as described above, in the pixel modulation degree calculation process, when any pixel formation portion is set as a focused pixel formation portion, a light modulation degree of the focused pixel formation portion in each sub-frame is obtained so that a target display color is reproduced in the focused pixel formation portion in a sub-frame in which a color component ratio of the target display color in the focused pixel formation portion and a light emission color component ratio of the LED unit 20 corresponding to the focused pixel formation portion are nearest each other, and that light from the LED unit 20 is shielded in the focused pixel formation portion in the other sub-frames.

### 1. 3 Effects

According to the present embodiment, in a liquid crystal display device that employs a field-sequential system, an LED of each color which is included in the LED unit 20 can obtain any light emission state in any sub-frame. Therefore, mixed-color display can be performed in each sub-frame. That is, one frame period is configured by four sub-frames in which mixed-color display is possible. Therefore, even when mixed-color display of a plurality of patterns is necessary to display a target image of an allocation area of a certain LED unit 20, the mixed-color display of the plurality of patterns can be performed one pattern-by-one pattern using a plurality of sub-frames. Accordingly, mixed-color display of a plurality of patterns can be performed in one frame period without using a time division system, while suppressing occurrence of color crosstalk. Therefore, according to the present embodiment, occurrence of color breakup is more effectively suppressed. As described above, a liquid crystal display device using a field-sequential system capable of more effectively suppressing occurrence of color breakup is realized.

### 1. 4 Modifications

Hereinafter, modifications of the first embodiment are described.

<1. 4. 1 First Modification>

In the pixel modulation degree calculation process according to the first embodiment, a sub-frame is detected, in which light arrives whose color component ratio is nearest to a target display color out of color component ratios of light which arrives at the selected pixel, and a light modulation degree of the selected pixel in each sub-frame is determined so that the target display color appears in the selected pixel by using only the detected sub-frame. However, the present invention is not limited to this. Regarding the selected pixel, there is also a case that a color near a target display color can be reproduced by mixing arrival light in a plurality of sub-frames. Therefore, a light modulation degree of a selected pixel in each of a plurality of sub-frames may be adjusted. In this case, in the pixel modulation degree calculation process (see FIG. 20), in step S310, a sub-frame combination (one or a plurality of sub-frames) in which a color nearest the target display color appears in the selected pixel is detected. In step S320, a light modulation degree of the selected pixel in one or a plurality of sub-frames detected in step S310 is calculated. In this way, it becomes possible to display a color nearer a target display color in each pixel formation portion.

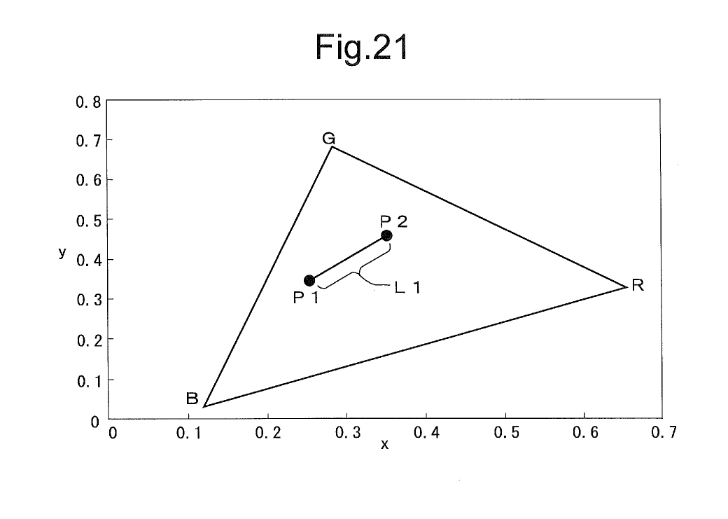

It should be noted that the configuration may be such that color reproduction by mixing the arrival light in the plurality of sub-frames is possible only when a difference between a color of arrival light in the sub-frame in which light whose color component ratio is nearest to the target display color arrives and the target display color is larger than a prescribed value. As the “difference between a color of arrival light and a target display color”, it is possible to employ a relative difference between both colors when respective colors are expressed by an HSV color space, a relative difference between both colors when respective colors are expressed by using xy chromaticity coordinates, and a relative difference between both colors when respective colors are expressed by using u′ v′ chromaticity coordinates, for example. When a coordinate P1 of a color of arrival light and a coordinate P2 of a target display color are expressed on an xy chromaticity diagram as shown in FIG. 21, for example, a distance L1 between P1 and P2 may be compared with a prescribed value.

When color reproduction by mixing arrival light in a plurality of sub-frames is made possible, it is anticipated that a risk of occurrence of color breakup becomes high. Then, the configuration may be such that color reproduction by mixing arrival light in a plurality of sub-frames is possible only when a difference between a color obtained by mixing arrival light in a plurality of sub-frames and a target display color is smaller than a prescribed value. Accordingly, occurrence of color breakup attributable to display of a target display color by time division is suppressed.

<1. 4. 2 Second Modification>

In the above embodiment, the largest value out of required intensities that are related to the respective light emission color component ratio candidates is set as color component ratio intensity of the corresponding light emission color component ratio candidate. However, the present invention is not limited to this. When required intensities of a plurality of pixels are present as required intensities that are related to a certain light emission color component ratio candidate, a sum of the required intensities of the plurality of pixels may be set as color component ratio intensity of the light emission color component ratio candidate. In the example shown in FIG. 17, a sum of required intensities of four pixels ((X, Y)=(1, 1), (1, 2), (2, 1), (2, 2)) may be set as color component ratio intensity of a light emission color component ratio candidate α.

<1. 4. 3 Third Modification>

In the above embodiment, one frame period is configured by four sub-frames. However, the present invention is not limited to this. When one frame period is configured by at least two sub-frames, the present invention can be applied. For example, one frame period may be configured by five sub-frames.

### 2. Second Embodiment

### 2. 1 Overview

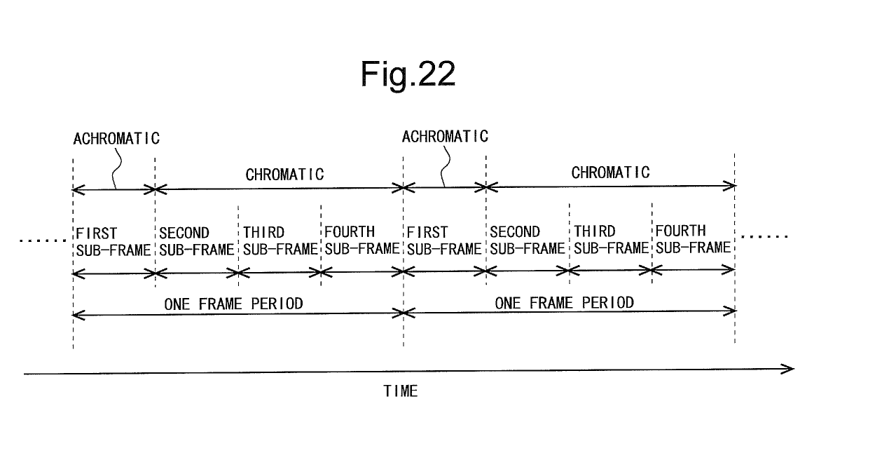

A total configuration of a liquid crystal display device, a configuration of the backlight unit 200, and a configuration of a pixel area in the display unit 100 are similar to those in the first embodiment. Therefore, their descriptions are omitted (see FIG. 1 to FIG. 3). Like in the first embodiment, one frame period is configured by a plurality of sub-frames (four sub-frames in the present description). However, as described later, unlike in the first embodiment, one of a plurality of sub-frames (first sub-frame in the present description) is set as a sub-frame for performing achromatic display (hereinafter, also referred to as an “achromatic sub-frame”). Sub-frames other than the achromatic sub-frame are set as sub-frames for performing chromatic display (hereinafter, also referred to as “chromatic sub-frames”). That is, in the present embodiment, as shown in FIG. 22, one frame period is configured by the first sub-frame as an achromatic sub-frame and second to fourth sub-frames as chromatic frames.

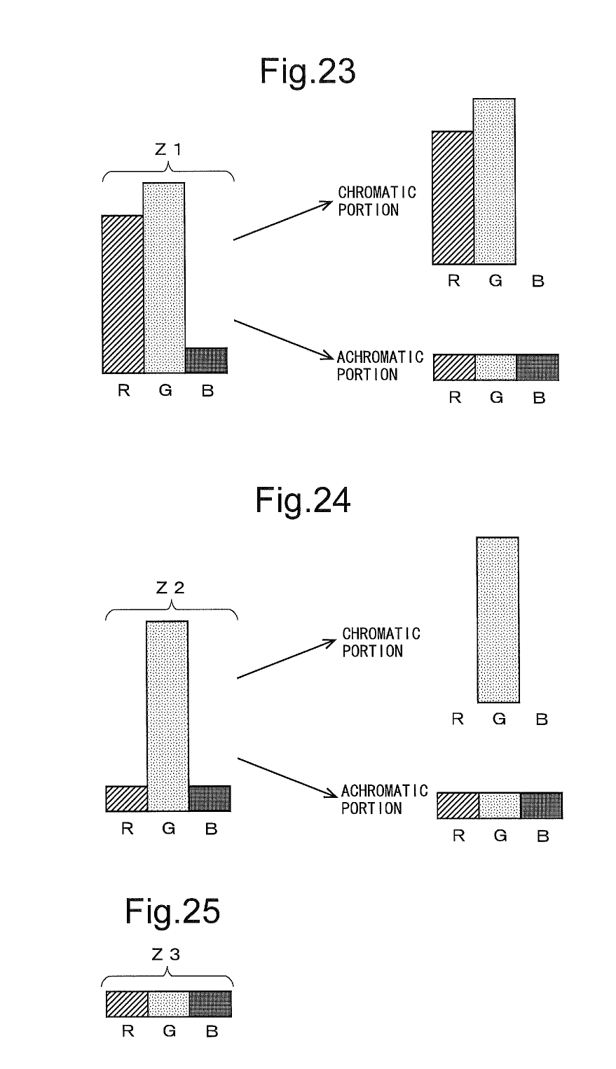

A color whose color component ratio is Z1 as shown in FIG. 23 is focused, for example. This color can be divided into a chromatic portion and an achromatic portion as shown in FIG. 23. At this time, the chromatic portion is a combination of two color components (a combination of a red color component and a green color component). Also, a color whose color component ratio is Z2 as shown in FIG. 24 is focused, for example. This color can be also divided into a chromatic portion and an achromatic portion as shown in FIG. 24. At this time, the chromatic portion is one color component (green color component). In this way, a chromatic portion of a color expressed by using a red color (R), a green color (G), and a blue color (B) is expressed by not more than two colors. Note that, a color whose color component ratio is Z3 as shown in FIG. 25 has only an achromatic portion. As can be understood from the above, in the chromatic sub-frames, an LED of at least one color out of the red-color LED 21, the green-color LED 22, and the blue-color LED 23 included in each LED unit 20 becomes in a lighting-off state.

### 2. 2 Sub-Frame Image Generation Process

Next, a sub-frame image generation process in the present embodiment is described. An overall flow of the sub-frame image generation process (see FIG. 9) is similar to that in the first embodiment. That is, a color component ratio extraction process, a light emission color component ratio selection process, and a pixel modulation degree calculation process are performed in order. Hereinafter, regarding each process, points different from those in the first embodiment are mainly described.

<2. 2. 1 Color Component Ratio Extraction Process>

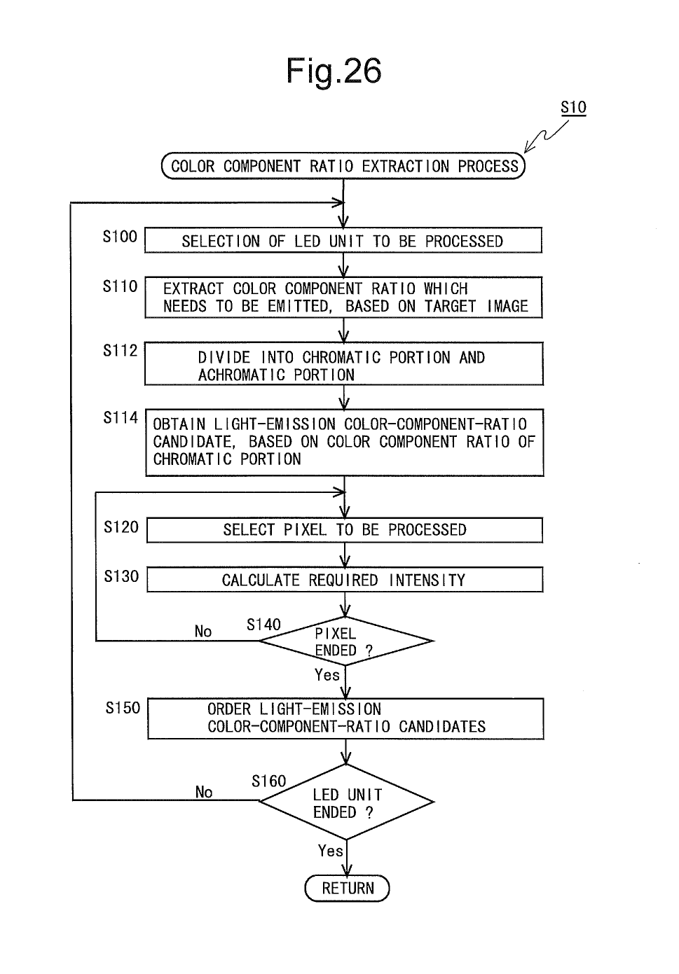

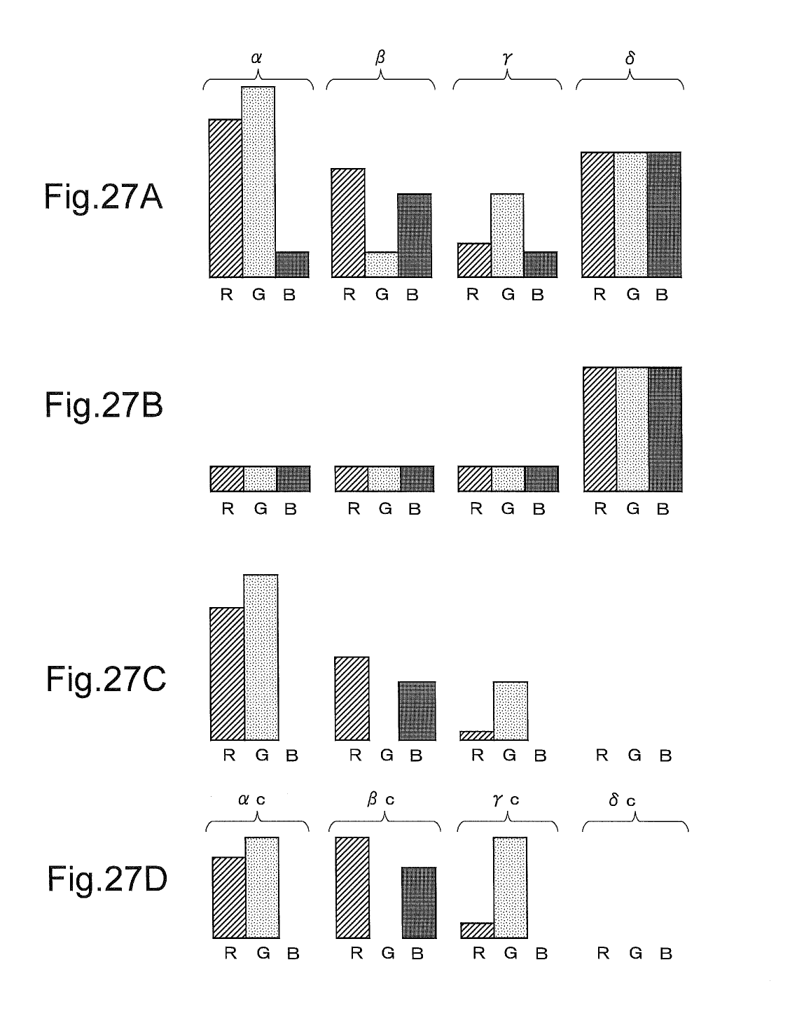

FIG. 26 is a flowchart showing a sequence of the color component ratio extraction process in the present embodiment. According to the present embodiment, in step S110, based on a target image in an allocation area of a selected LED unit, color component ratios necessary to reproduce a color (target display color) that constitutes the target image are extracted. Thereafter, division into a chromatic portion and an achromatic portion is performed for each color component ratio extracted in step S110 (step S112). When four color component ratios as indicated by α, β, γ, and δ in FIG. 27A are extracted in step S110 as color component ratios (a component value of each color is also taken into account in this case) necessary to reproduce a target display color, for example, each color component ratio is divided into an achromatic portion as shown in FIG. 27B and a chromatic portion as shown in FIG. 27C, in step S112. Thereafter, based on a color component ratio of the chromatic portion, light emission color component ratio candidates are obtained (step S114). When color component ratios of chromatic portions are as shown in FIG. 27C, color component ratios as indicated by αc, βc, γc, and δc in FIG. 27D are obtained as light emission color component ratio candidates.

In step S130, the required intensity D1 is calculated by the equation (1) in a similar manner to that in the first embodiment. However, in the present embodiment, the largest value among respective component values of a red color component, a green color component, and a blue color component of a chromatic portion in a selected pixel is set as the color intensity D2. Note that, a total value of the respective component values of the red color component, the green color component, and the blue color component of the chromatic portion in the selected pixel may be set as the color intensity D2. Further, by taking account of a visibility characteristic of each color, a value obtained by weighted-averaging the respective component values of the red color component, the green color component, and the blue color component in the chromatic portion may be set as the color intensity D2.

In step S150, like in the first embodiment, ordering is performed to the light emission color component ratio candidates. For example, when color component ratios of chromatic portions are as shown in FIG. 27C, ordering is performed such that “a first order: the light emission color component ratio candidate αc, a second order: the light emission color component ratio candidate βc, a third order: the light emission color component ratio candidate γc, and a fourth order: the light emission color component ratio candidate δc” is established.

<2. 2. 2 Light Emission Color Component Ratio Selection Process>

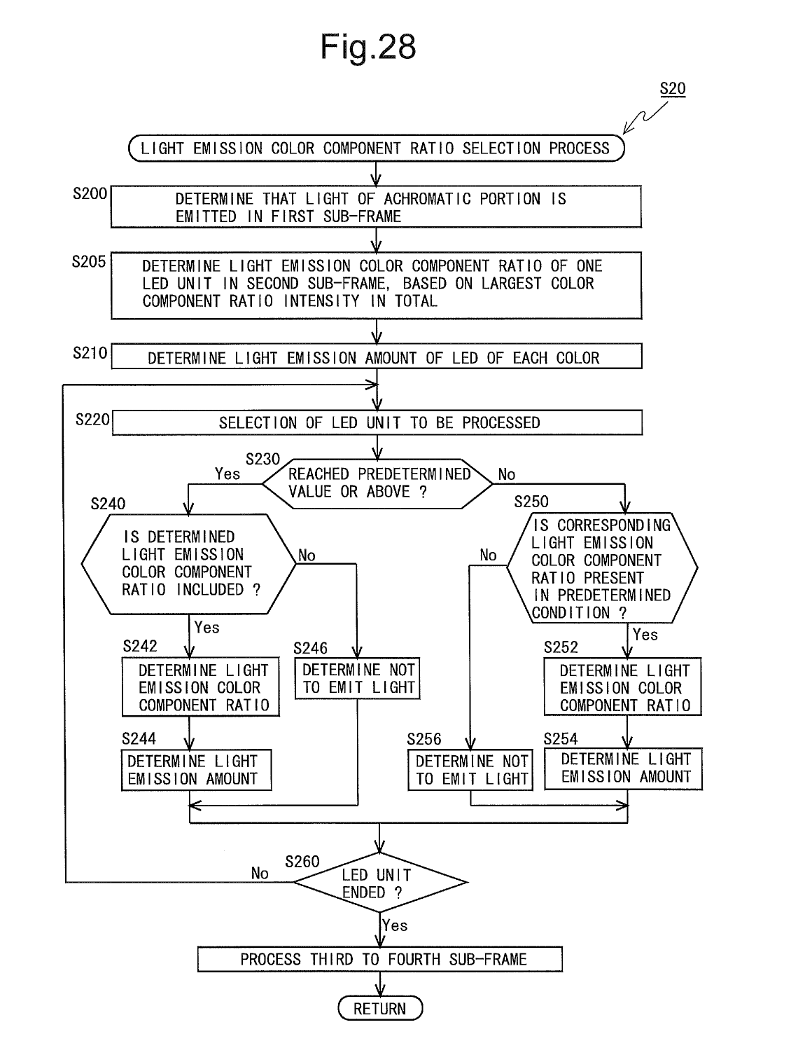

FIG. 28 is a flowchart showing a sequence of the light emission color component ratio selection process in the present embodiment. In the present embodiment, first, regarding all LED units 20, it is determined that light emission for reproducing an achromatic portion is performed in the first sub-frame (step S200). Thereafter, in a similar manner to that in step S200 in the first embodiment, a light emission color component ratio of one LED unit 20 in the second sub-frame is determined (step S205). Thereafter, in a similar manner to that in the first embodiment, a light emission color component ratio in the second sub-frame is determined regarding all LED units 20 included in the backlight unit 200 (step S210 to step S260). Further, thereafter, in a similar manner to that in the second sub-frame, processes in third to fourth sub-frames are performed in order.

It should be noted that, in the present embodiment, a first sub-frame out of a plurality of sub-frames is set as an achromatic sub-frame. However, any sub-frame out of a plurality of sub-frames may be set as the achromatic sub-frame.

Focusing attention on only a relationship between the area indicated by the reference character 62 and the area indicated by the reference character 63 in FIG. 12, a specific way of determining a light emission color component ratio in the present embodiment is described. Also in this case, the LED unit 20 provided corresponding to the area 62 is also referred to as a “first unit”, and the LED unit 20 provided corresponding to the area 63 is also referred to as a “second unit”. Note that, light emission color component ratio candidates based on respective chromatic portions of color component ratios α, β, γ, and δ are set as αc, βc, γc, and δc. It is assumed that regarding color component ratio intensities, “a first order: the light emission color component ratio candidate αc of the first unit, a second order: the light emission color component ratio candidate βc of the second unit, a third order: the light emission color component ratio candidate γc of the second unit, a fourth order: the light emission color component ratio candidate γc of the first unit, a fifth order: the light emission color component ratio candidate δc of the first unit, a sixth order: the light emission color component ratio candidate βc of the first unit, and a seventh order: the light emission color component ratio candidate δc of the second unit” is established. Further, it is assumed that even when an LED unit becomes in a lighting-on state based on any light emission color component ratio candidate, due to light emitted from an LED unit in one area, light whose amount is equal to or larger than a prescribed value arrives at the other area. When the light emission color component ratio selection process is performed in the above conditions, the light emission color component ratios of the first unit and the second unit in each sub-frame are determined as follows.

First, both in the first unit and the second unit, a first sub-frame is set as an achromatic sub-frame. Note that, in the achromatic sub-frame, the red-color LED 21, the green-color LED 22, and the blue-color LED 23 become in a lighting-on state in the same light emission intensity. However, these three LEDs are not necessarily all required to be set in the same light emission intensities. It is sufficient that light emission intensities of the red-color LED 21, the green-color LED 22, and the blue-color LED 23 included in each LED unit 20 are adjusted so that a color temperature of a display color becomes within a range of 5000 K to 13000 K. Next, because the first order of color component ratio intensity is the light emission color component ratio candidate αc of the first unit, the light emission color component ratio candidate αc is set as a light emission color component ratio of the first unit in the second sub-frame. Light whose amount is equal to or larger than a prescribed value arrives at the area 63 due to light emitted from the first unit, and the second unit does not have the light emission color component ratio candidate ac. Therefore, it is determined that the second unit does not emit light in the second sub-frame. Next, a light emission color component ratio candidate that has the largest color component ratio intensity among light emission color component ratio candidates remaining at this stage is the light emission color component ratio candidate βc of the second unit in the second order. Therefore, the light emission color component ratio candidate βc is set as a light emission color component ratio of the second unit in the third sub-frame. Light whose amount is equal to or larger than a prescribed value arrives at the area 62 due to light emitted from the second unit, and the first unit has the light emission color component ratio candidate βc. Therefore, the light emission color component ratio candidate βc is set as a light emission color component ratio of the first unit in the third sub-frame. Hereinafter, in a similar manner, the light emission color component ratio candidate γc is set as light emission color component ratios of the first unit and the second unit in the fourth sub-frame.

<2. 2. 3 Pixel Modulation Degree Calculation Process>

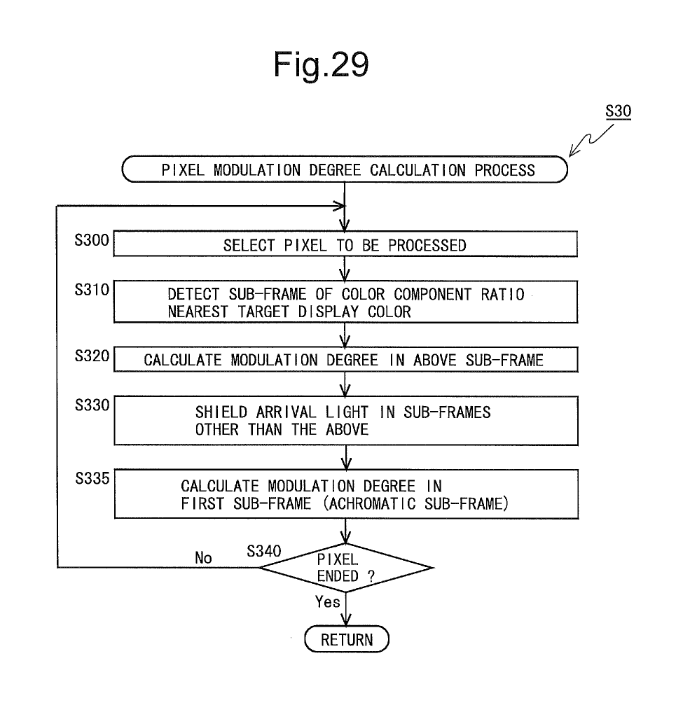

FIG. 29 is a flowchart showing a sequence of a pixel modulation degree calculation process in the present embodiment. In the present embodiment, in step S310, from the chromatic sub-frames, a sub-frame is detected, in which light arrives whose color component ratio is nearest to a target display color out of color component ratios of light which arrives at the selected pixel. In step S320, a light modulation degree is determined so that a chromatic portion of the target display color appears in the selected pixel in the detected sub-frame. In step S330, a light modulation degree of the selected pixel is determined so that arrival light is shielded in a sub-frame other than the detected sub-frame out of the chromatic sub-frames. In step S335, a light modulation degree of the selected pixel in the first sub-frame (achromatic sub-frame) is determined. In this step S335, a light modulation degree is determined so that an achromatic component is compensated which becomes in shortage when it is assumed that display based on the light modulation degree determined in step S320 and step S330 has been performed.

### 2. 3 Effects

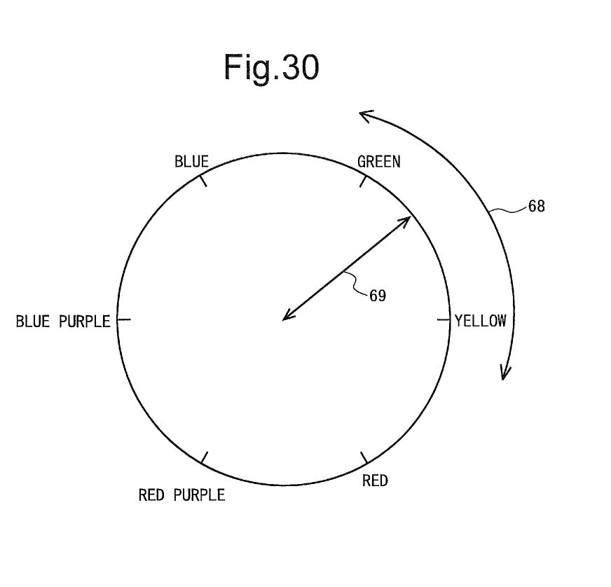

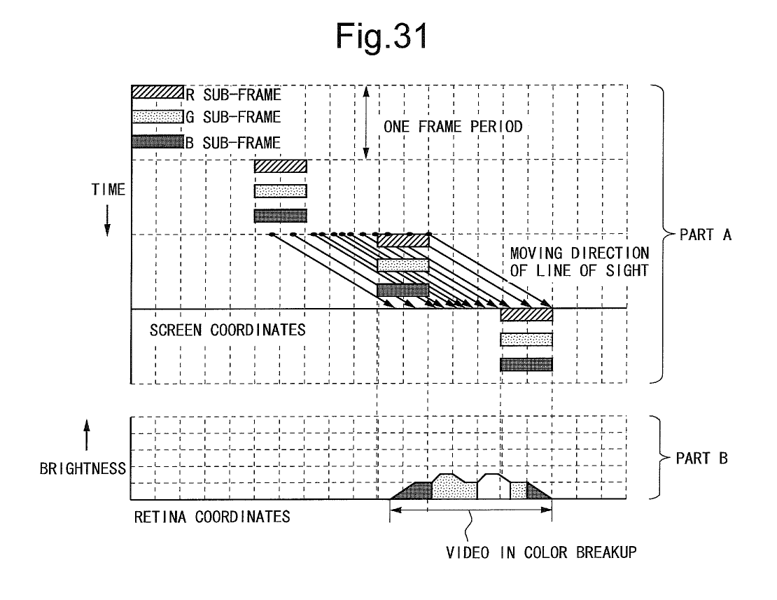

According to the present embodiment, like in the first embodiment, a liquid crystal display device using a field-sequential system capable of more effectively suppressing occurrence of color breakup is realized. According to the present embodiment, at least one of a plurality of sub-frames that configure one frame period is set as a sub-frame for performing achromatic display (achromatic sub-frame), and chromatic display is performed by using the other sub-frames (chromatic sub-frames). Therefore, in each chromatic sub-frame, color reproduction based on a combination of three color components is not performed, and color reproduction based on a combination of at most two color components is performed. From the above, in reproducing a target display color, adjustment of a hue angle (see an arrow indicated by a reference character 68 in FIG. 30) and adjustment of chromaticness (see an arrow indicated by a reference character 69 in FIG. 30) can be performed in different sub-frames. Accordingly, arithmetic processing of a light modulation degree that is necessary to reproduce a target display color becomes easy.

### 2. 4 Modification

In the pixel modulation degree calculation process according to the second embodiment, the light modulation degree of the selected pixel in each sub-frame is determined so that the color near the target display color appears in the selected pixel by mixing arrival light to the selected pixel in one of the chromatic sub-frames and arrival light to the selected pixel in the achromatic sub-frame. However, the present invention is not limited to this. Regarding the selected pixel, there is a case that a color near a target display color can be reproduced by mixing arrival light in the plurality of chromatic sub-frames with arrival light in the achromatic sub-frame. Therefore, a light modulation degree of a selected pixel in each of the plurality of chromatic sub-frames may be adjusted. Accordingly, like in the first modification of the first embodiment, a color nearer target display color can be reproduced in each pixel formation portion.

It should be noted that the configuration may be such that color reproduction by mixing the arrival light in the plurality of chromatic sub-frames and the arrival light in the achromatic sub-frame is made possible only when a difference between “the color obtained by mixing the arrival light in the chromatic sub-frame in which the light whose color component ratio is nearest to the target display color arrives and the arrival light in the achromatic sub-frame” and the “target display color” is larger than a prescribed value.

By the way, when the color reproduction by mixing the arrival light in the plurality of chromatic sub-frames and the arrival light in the achromatic sub-frame is made possible, it is anticipated that a risk of occurrence of color breakup becomes high. Therefore, the configuration may be such that the color reproduction by mixing the arrival light in the plurality of chromatic sub-frames and the arrival light in the achromatic sub-frame is made possible only when a difference between “the color obtained by mixing the arrival light in the plurality of chromatic sub-frames and the arrival light in the achromatic sub-frame” and the “target display color” is smaller than a prescribed value. Accordingly, occurrence of color breakup attributable to display of a target display color by time division is suppressed.

Further, regarding calculation of color component ratio intensity, in a similar manner to that in the second modification of the first embodiment, when the required intensities of the plurality of pixels are present as the required intensities that are related to the certain light emission color component ratio candidate, a sum of the required intensities of the plurality of pixels may be set as color component ratio intensity of the light emission color component ratio candidate. Further, in a similar manner to that in the third modification of the first embodiment, one frame period may be configured by a plurality of sub-frames other than four sub-frames. Furthermore, according to the present embodiment, only one sub-frame out of the plurality of sub-frames is set as the achromatic sub-frame. However, two or more sub-frames out of the plurality of sub-frames may be set as achromatic sub-frames. That is, the configuration may be such that one frame period is configured by a plurality of sub-frames in which mixed-color display can be performed, and that achromatic display is performed in at least one sub-frame out of the plurality of sub-frames.

### 3. Image Display Device Including Pixel Modulation Degree Calculating Unit

As an image display device including the above pixel modulation degree calculating unit 46, image display devices in various configurations as described below can be considered.

(Note 1)

An image display device that has a display unit including a plurality of pixel formation portions arranged in a matrix form and a backlight for irradiating the display unit with light, and that performs color display by dividing one frame period into a plurality of sub-frame periods and by changing over, in each sub-frame period, colors of light sources which become in a lighting-on state, the backlight including a light source group made up of light sources of a plurality of colors which are capable of controlling the lighting-on state/a lighting-off state for each color, the image display device comprising:

a pixel modulation degree calculating unit that obtains a light modulation degree of each pixel formation portion in each sub-frame period, based on a light emission amount in each sub-frame period of the light sources of the plurality of colors included in the light source group and a target display color included in a target image to be displayed in the display unit with spending one frame period.

(Note 2)

The image display device according to note 1, wherein

when a color component ratio in emitting light of the light sources of the plurality of colors included in the light source group is called a light emission color component ratio and also when any pixel formation portion is called a focused pixel formation portion, the pixel modulation degree calculating unit obtains a light modulation degree of the focused pixel formation portion in each sub-frame period so that a target display color is reproduced in the focused pixel formation portion in a sub-frame period in which a color component ratio of a target display color in the focused pixel formation portion and a light emission color component ratio of the light source group become nearest each other and that light from the light source group is shielded in the focused pixel formation portion in the other sub-frame periods.

(Note 3)

The image display device according to note 2, wherein

when a color reproduced in the focused pixel formation portion by mixing light emitted from the light source group in the plurality of sub-frame periods becomes nearer a target display color in the focused pixel formation portion than a color reproduced in the focused pixel formation portion by the light emitted from the light source group in one sub-frame period, the pixel modulation degree calculating unit obtains a light modulation degree of the focused pixel formation portion in each sub-frame period so that the target display color is reproduced in the focused pixel formation portion by using the plurality of sub-frame periods and that light from the light source group is shielded in the focused pixel formation portion in the other sub-frame periods.

(Note 4)

The image display device according to note 3, wherein

only when a difference between the color reproduced in the focused pixel formation portion and the target display color in the focused pixel formation portion is larger than a prescribed value in a sub-frame period in which a light emission color component ratio of the light source group and a color component ratio of the target display color in the focused pixel formation portion become nearest each other, the pixel modulation degree calculating unit obtains a light modulation degree so that the target display color is reproduced in the focused pixel formation portion by using the plurality of sub-frame periods.

(Note 5)

The image display device according to note 3, wherein

only when a difference between the color reproduced in the focused pixel formation portion by mixing light emitted from the light source group in the plurality of sub-frame periods and the target display color in the focused pixel formation portion is smaller than the prescribed value, the pixel modulation degree calculating unit obtains a light modulation degree so that the target display color is reproduced in the focused pixel formation portion by using the plurality of sub-frame periods.

(Note 6)

The image display device according to note 1, wherein

a lighting-on state/a lighting-off state and a light emission amount of the light sources of the plurality of colors included in the light source group are controlled so that achromatic display is performed in at least one sub-frame period out of a plurality of sub-frame periods that configure each frame period.

(Note 7)

The image display device according to note 6, wherein

the light sources of the plurality of colors included in the light source group are light sources of three colors of a red color, a green color, and a blue color, and

when a color component ratio in emitting light of the light sources of the plurality of colors included in the light source group is called a light emission color component ratio, when a sub-frame period in which achromatic display is performed is called an achromatic sub-frame period, when a sub-frame period in which chromatic display is performed is called a chromatic sub-frame period, and when any pixel formation portion is called a focused pixel formation portion, the pixel modulation degree calculating unit obtains a light modulation degree of the focused pixel formation portion in each sub-frame period so that the chromatic portion of the target display color is reproduced in the focused pixel formation portion in the chromatic sub-frame period in which the color component ratio of the target display color in the focused pixel formation portion and the light emission color component ratio of the light source group become nearest each other, that light from the light source group is shielded in the focused pixel formation portion in the other chromatic sub-frame periods, and that the achromatic portion of the target display color is reproduced in the focused pixel formation portion in the achromatic sub-frame period.

(Note 8)

The image display device according to note 7, wherein

when a color reproduced in the focused pixel formation portion by mixing light emitted from the light source group in the plurality of chromatic sub-frame periods and light emitted from the light source group in the achromatic sub-frame period is nearer the target display color in the focused pixel formation portion than a color reproduced in the focused pixel formation portion by mixing light emitted from the light source group in one chromatic sub-frame period and light emitted from the light source group in the achromatic sub-frame period, the pixel modulation degree calculating unit obtains a light modulation degree of the focused pixel formation portion in each sub-frame period so that a chromatic portion of the target display color is reproduced in the focused pixel formation portion by using the plurality of chromatic sub-frame periods, that light from the light source group is shielded in the focused pixel formation portion in the other chromatic sub-frame periods, and that the achromatic portion of the target display color is reproduced in the focused pixel formation portion in the achromatic sub-frame period.

(Note 9)

The image display device according to note 8, wherein

only when a difference between the target display color in the focused pixel formation portion and the color reproduced in the focused pixel formation portion by mixing light emitted from the light source group in the chromatic sub-frame period in which a light emission color component ratio of the light source group and the color component ratio of the target display color in the focused pixel formation portion become nearest each other and light emitted from the light source group in the achromatic sub-frame period is larger than a prescribed value, the pixel modulation degree calculating unit obtains a light modulation degree so that the target display color is reproduced in the focused pixel formation portion by using the plurality of sub-frame periods.

(Note 10)

The image display device according to note 8, wherein

only when a difference between the target display color in the focused pixel formation portion and the color reproduced in the pixel formation portion by mixing light emitted from the light source group in the plurality of chromatic sub-frame periods and light emitted from the light source group in the achromatic sub-frame period is smaller than a prescribed value, the pixel modulation degree calculating unit obtains a light modulation degree so that the chromatic portion of the target display color is reproduced in the focused pixel formation portion by using the plurality of chromatic sub-frame periods.

(Note 11)

The image display device according to note 1, wherein

each pixel formation portion includes a pixel electrode, a common electrode which is an electrode provided in common in the plurality of pixel formation portions and is arranged to face the pixel electrode so as to be applied with a predetermined potential, and a liquid crystal sandwiched between the pixel electrode and the common electrode, and

in each sub-frame period, the liquid crystal is driven by application of a potential based on a light modulation degree obtained by the pixel modulation degree calculating unit to a pixel electrode included in each pixel formation portion.

### 4. Others

In each of the above embodiments, description has been made by taking employment of LEDs of three colors for a backlight as an example. However, the present invention is not limited to this. For example, LEDs of four or more colors may be employed as a backlight. Further, a light source other than an LED may be employed.

In each of the above embodiments, description has been made by taking a liquid crystal display device as an example. However, the present invention is not limited to this. The present invention can be also applied to a display device other than a liquid crystal display device when the display device has a light irradiating unit (such as a backlight) including a light source group made up of light sources of a plurality of colors and also employs a system for changing over for each sub-frame a color of a light source which becomes in a lighting-on state.

### DESCRIPTION OF REFERENCE CHARACTERS

20: LED UNIT
42: COLOR COMPONENT RATIO EXTRACTING UNIT
44: LIGHT EMISSION COLOR COMPONENT RATIO SELECTING UNIT
46: PIXEL MODULATION DEGREE CALCULATING UNIT
100: DISPLAY UNIT
200: BACKLIGHT UNIT
300: PANEL DRIVE CIRCUIT
400: SUB-FRAME IMAGE GENERATING UNIT
DIN: INPUT IMAGE SIGNAL
Dcol: COLOR COMPONENT RATIO DATA
DL: LIGHT EMISSION DATA
DV: DIGITAL VIDEO SIGNAL
S: LIGHT SOURCE CONTROL SIGNAL

1. An image display device that has a display unit including a plurality of pixel formation portions arranged in a matrix form and a light irradiating unit for irradiating the display unit with light, and that performs color display by dividing one frame period into a plurality of sub-frame periods and by changing over, in each sub-frame period, colors of light sources which become in a lighting-on state, the light irradiating unit including a light source group made up of light sources of a plurality of colors which are capable of controlling the lighting-on state/a lighting-off state for each color, wherein
the light irradiating unit includes a plurality of light source groups so that each light source group corresponds to a part of the plurality of pixel formation portions,
one frame period is configured by a plurality of sub-frame periods in which mixed-color display is possible by setting light sources of a plurality of colors in the lighting-on state,
a color of a light source that is set in the lighting-on state in each sub-frame period is determined for each light source group, and
achromatic display is performed in at least one sub-frame period among the plurality of sub-frame periods.

2. (canceled)

3. The image display device according to claim 1, wherein
the light sources of the plurality of colors included in the light source group are light sources of three colors of a red color, a green color, and a blue color, and
in a sub-frame period in which achromatic display is performed, light sources of a red color, a green color, and a blue color that are included in the light source group become in the lighting-on state with the same light emission intensity, or all light sources of a red color, a green color, and a blue color that are included in the light source group become in the lighting-off state.

4. The image display device according to claim 1, wherein
the light sources of the plurality of colors included in the light source group are light sources of three colors of a red color, a green color, and a blue color, and
in a sub-frame period in which achromatic display is performed, light emission intensities of light sources of a red color, a green color, and a blue color included in the light source group are adjusted so that a color temperature of a display color becomes within a range of 5000K to 13000 K.

5. The image display device according to claim 1, wherein
the light sources of the plurality of colors included in the light source group are light sources of three colors of a red color, a green color, and a blue color, and
in a sub-frame period in which achromatic display is not performed, a light source of at least one color of light sources of a red color, a green color, and a blue color included in the light source group becomes in the lighting-off state.

6. The image display device according to claim 1, comprising:
a color component ratio extracting unit for extracting a color component ratio for reproducing a target display color included in a target image as a light emission color component ratio candidate, from the target image to be displayed in the display unit with spending one frame period; and
a light emission color component ratio selecting unit for selecting as a light emission color component ratio a color component ratio when the light sources of a plurality of colors included in the light source group emit light in each sub-frame period, from among light emission color component ratio candidates extracted by the color component ratio extracting unit, wherein
each light source can take any light emission state of either the lighting-on state or the lighting-off state in each sub-frame period.

7. The image display device according to claim 6, wherein
the color component ratio extracting unit extracts the light emission color component ratio candidate from an image of a corresponding portion of the target image for each light source group, and
the light emission color component ratio selecting unit selects the light emission color component ratio for each light source group.

8. The image display device according to claim 1, comprising a pixel modulation degree calculating unit that obtains a light modulation degree of each pixel formation portion in each sub-frame period, based on a light emission amount in each sub-frame period of the light sources of the plurality of colors included in the light source group and a target display color included in a target image to be displayed in the display unit with spending one frame period.

9. The image display device according to claim 8, wherein
when a color component ratio in emitting light of the light sources of the plurality of colors included in the light source group is called a light emission color component ratio and also when any pixel formation portion is called a focused pixel formation portion, the pixel modulation degree calculating unit obtains a light modulation degree of the focused pixel formation portion in each sub-frame period so that a target display color is reproduced in the focused pixel formation portion in a sub-frame period in which a color component ratio of a target display color in the focused pixel formation portion and a light emission color component ratio of the light source group become nearest each other and that light from the light source group is shielded in the focused pixel formation portion in the other sub-frame periods.

10. The image display device according to claim 9, wherein
when any pixel formation portion is called a focused pixel formation portion, and when a color reproduced in the focused pixel formation portion by mixing light emitted from the light source group in a plurality of sub-frame periods is nearer a target display color in the focused pixel formation portion than a color reproduced in the focused pixel formation portion by light emitted from the light source group in one sub-frame period, the pixel modulation degree calculating unit obtains a light modulation degree of the focused pixel formation portion in each sub-frame period so that a target display color is reproduced in the focused pixel formation portion by using the plurality of sub-frame periods and that light from the light source group is shielded in the focused pixel formation portion in the other sub-frame periods.

11. The image display device according to claim 1, comprising:
a color component ratio extracting unit for extracting a color component ratio for reproducing a target display color included in a target image as a light emission color component ratio candidate, from the target image to be displayed in the display unit with spending one frame period;
a light emission color component ratio selecting unit for selecting as a light emission color component ratio a color component ratio when the light sources of a plurality of colors included in the light source group emit light in each sub-frame period, from among light emission color component ratio candidates extracted by the color component ratio extracting unit;
a light emission amount calculating unit for obtaining a light emission amount in each sub-frame period of the light sources of the plurality of colors included in the light source group, based on a light emission color component ratio selected by the light emission color component ratio selecting unit; and
a pixel modulation degree calculating unit for obtaining a light modulation degree of each pixel formation portion in each sub-frame period based on a light emission amount obtained by the light emission amount calculating unit and a target display color included in the target image.

12. The image display device according to claim 1, wherein each pixel formation portion includes a pixel electrode, a common electrode which is an electrode provided in common in the plurality of pixel formation portions and is arranged to face the pixel electrode so as to be applied with a predetermined potential, and a liquid crystal sandwiched between the pixel electrode and the common electrode, and
the liquid crystal is driven by application of a potential based on a target image to be displayed in the display unit with spending one frame period to a pixel electrode included in each pixel formation portion.

13. An image display method in an image display device that has a display unit including a plurality of pixel formation portions arranged in a matrix form and a light irradiating unit for irradiating the display unit with light, and that performs color display by dividing one frame period into a plurality of sub-frame periods and by changing over, in each sub-frame period, colors of light sources which become in the lighting-on state, the light irradiating unit including a light source group made up of light sources of a plurality of colors which are capable of controlling the lighting-on state/a lighting-off state for each color, wherein
the light irradiating unit includes a plurality of light source groups so that each light source group corresponds to a part of the plurality of pixel formation portions,
one frame period is configured by a plurality of sub-frame periods in which mixed-color display is possible by setting light sources of a plurality of colors in the lighting-on state,
a color of a light source that is set in the lighting-on state in each sub-frame period is determined for each light source group, and
achromatic display is performed in one sub-frame period among the plurality of sub-frame periods.
